(19) United States
(12) Patent Application Publication
(10) Pub. No.: US 2026/0195149 A1
(43) Pub. Date: Jul. 9, 2026

(54) USER INTERFACES AND OBJECT GRAPHS FOR CUSTOM LOCATION-BASED AND UNIFIED FIELD OBJECTS

(71) Applicant: People Center, Inc., San Francisco, CA (US)

(72) Inventors: Shabareesh Rajagopal, Bangalore (IN); Kevinkumar Amipara, San Francisco, CA (US); Amritesh Srivastava, Bengaluru (IN); Uddhav Mishra, Ajmer (IN); Madelin Louise Woods, Berkeley, CA (US); Ravi Kumar Singh, Bangalore (IN)

(21) Appl. No.: 19/071,468

(22) Filed: Mar. 5, 2025

(30) Foreign Application Priority Data
Jan. 8, 2025 (IN) 202511001666

(51) Int. Cl. G06F 9/451; G06F 3/0484

(52) U.S. Cl. CPC G06F 9/451; G06F 3/0484

(57) ABSTRACT

Systems, computer-implemented methods, applications, and user interfaces for receiving selection of at least one location-specific field associated with the location and corresponding to the one or more uniform object fields. For example, a computer-implemented method may include: providing one or more first interfaces for defining one or more custom uniform objects; receiving a location associated with the one or more custom uniform objects; receiving one or more uniform object fields of a uniform object associated with the location; generating, based on the location and the one or more uniform object fields, one or more second interfaces to one or more users for configuring at least one location-specific field; and receiving, via the one or more second interfaces, selection of at least one location-specific field associated with the location and corresponding to the one or more uniform object fields.

### CROSS-REFERENCE TO PRIORITY APPLICATIONS

The present application claims priority to Indian Application No. 202511001666, filed Jan. 8, 2025, which is incorporated by reference in its entirety herein.

### FIELD

The present disclosure generally relates to computer systems. More particularly, the present disclosure relates to using object graphs for location-based objects and unified field objects.

### BACKGROUND

Objects can be useful for providing graphical user interfaces. However, existing technologies fall short of providing sufficient location-based objects for unified field objects to be sufficiently useful in graphical user interfaces. Example embodiments disclosed herein provide a variety of solutions to these challenges.

### SUMMARY

Aspects and advantages of embodiments of the present disclosure will be set forth in part in the following description, or can be learned from the description, or can be learned through practice of the embodiments.

An example embodiment of the present disclosure is directed to a computer system that can include one or more hardware processors and one or more non-transitory computer-readable media that collectively store instructions that, when executed by the one or more processors, cause the computer system to perform operations. The operations can include providing one or more first interfaces for defining one or more custom unified field objects. The operations can include receiving a location associated with the one or more custom unified field objects. The operations can include receiving one or more unified field objects of a unified field object associated with the location. The operations can include generating, based on the location and the one or more unified field objects, one or more second interfaces to one or more users for configuring at least one location-based field. The operations can include receiving, via the one or more second interfaces, selection of at least one location-based field associated with the location and corresponding to the one or more unified field objects.

Another example aspect of the present disclosure is directed to a method. The method can include providing one or more first interfaces for defining one or more custom unified field objects. The method can include receiving a location associated with the one or more custom unified field objects. The method can include receiving one or more unified field objects of a unified field object associated with the location. The method can include generating, based on the location and the one or more unified field objects, one or more second interfaces to one or more users for configuring at least one location-based field. The method can include receiving, via the one or more second interfaces, selection of at least one location-based field associated with the location and corresponding to the one or more unified field objects.

Other aspects of the present disclosure are directed to various systems, apparatuses, non-transitory computer-readable media, user interfaces, and devices for providing no-code and low-code application development and user interface customization. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations, according to example embodiments of the present disclosure.

FIG. 2 depicts a block diagram of an example of a computing device, according to example embodiments of the present disclosure.

FIG. 3 depicts a block diagram of an example computing environment including multiple computing systems, according to example embodiments of the present disclosure.

FIG. 4 shows an example flow diagram for example systems described herein.

FIG. 5 shows an example flow diagram, according to some embodiments.

FIG. 6A shows an example GUI page for a workflow associated with creation of a custom unified field object.

FIG. 6B shows an example location GUI page, according to certain embodiments.

FIG. 6C shows an example object description interface, according to certain embodiments.

FIG. 6D shows an example employment type GUI page, according to certain examples.

FIG. 6E shows an example object field type interface that allows the user to select one or more object field type selectors and/or object field subtype selectors.

FIG. 6F shows an example object label interface according to certain embodiments.

FIG. 6G shows an example object field type interface according to certain embodiments.

FIG. 6H shows an example object field type interface according to certain embodiments.

FIG. 7A shows an example location-specific object interface, according to certain embodiments.

FIG. 7B shows an example location-specific object interface for generating work location details that includes a plurality of location-specific object field selectors.

FIG. 7C shows an example location-specific object interface that can allow a user to select employment details using om location-specific object field selectors.

FIG. 7D shows an example of a location-specific object interface that allows a user to select role information for an employee using one or more location-specific object field selectors.

FIG. 8 depicts a flow diagram of an example method for generating one or more second interfaces to one or more users for configuring at least one location-specific field, according to example embodiments of the present disclosure.

Reference numerals that are repeated across plural figures are intended to identify the same features in various implementations.

### DETAILED DESCRIPTION

Generally, the present disclosure is directed to systems and methods for using and creating custom location-based objects and/or unified field objects. Such objects can be valuable for creating and using custom graphical user interfaces associated with location-based details. Systems and methods described herein can allow a user to generate new and/or customize existing custom location-based objects and/or custom unified field objects for one or more custom graphical user interfaces. The custom location-based objects and unified field objects can provide many technical effects or other technical improvements. For example, systems described herein can improve data structures, such as object data graph structures, that can be used to manage and/or store data.

Embodiments described herein can include user interfaces for defining custom unified field objects. For example, a system may provide a first interface for defining a custom unified field object (e.g., by a first user) associated with a location. The system can receive a location associated with the custom unified field object. Additionally or alternatively, the location may be associated with a location of a second user. The system may receive one or more unified field objects of the custom unified field object associated with the location. A second user interface can be generated that uses the custom unified field object. The system can generate one or more second interfaces to one or more users for configuring at least one location-based field. The one or more second interfaces may be based on the location and the one or more unified field objects.

In some embodiments, the system can receive, via the one or more second interfaces, selection of at least one location-based field associated with the location and corresponding to the one or more unified field objects. In some example embodiments, a user can provide a custom definition for one or more custom unified field objects. The custom definition can include, for example, a plurality of unified field objects, with each unified field object having a field name and field type (e.g., integer, timestamp, date, string, phone number, currency, file attachment, etc.). Based on the custom definition, a computing system can automatically generate one or more interfaces (e.g., graphical user interfaces, webhooks, APIs, file upload interfaces, etc.) for creating, reading, updating, and/or deleting a unified field object corresponding to the custom unified field object. Additionally, the computing system can automatically generate one or more interfaces for customizing applications and user interfaces for processing data associated with a custom unified field object type and/or a rule type. For example, a custom unified field object interface can allow a user to define a custom unified field object without providing any computer code in a computer programming language.

The system may receive one or more unified field objects of the unified field object via the one or more first interfaces. The system can receive, via the one or more first interfaces, an object field type, such as from a user. The object field type may be associated with at least one of the one or more unified field objects.

In some embodiments, the system can generate, based on a received object field type, at least one location-based field. The location-based field(s) may be configured to be selected within one or more second interfaces. The system may generate, via the one or more second interfaces, a subset of available fields based on the object field type and the at least one location-based field, wherein selection of the at least one location-based field is from the subset of available fields. The one or more first interfaces can include a graphical user interface that allows a user to generate a no-code definition of the one or more custom unified field objects.

The system may receive (e.g., via the one or more first interfaces) a second location associated with the one or more custom unified field objects and/or receiving one or more second unified field objects of a second unified field object associated with the second location. The system may generate, based on the second location and the one or more second unified field objects, one or more second interfaces for configuring at least one second location-based field. The system can receive via the one or more second interfaces, selection of at least one location-based field associated with the second location and corresponding to the one or more second unified field objects.

The system can receive (e.g., via the one or more first interfaces) a second object field type associated with at least one of the one or more second unified field objects and/or generate the at least one location-based field for selection within the one or more second interfaces, based on the received second object field type. In some embodiments, the system may generate, via the one or more second interfaces, a second subset of available fields, but not the subset of available fields, based on the second object field type and the at least one second location-based field. Selection of the at least one second location-based field is from the second subset of available fields.

As described herein, systems may include object graphs. For example, the system may work as part of an object graph comprising nodes and directed edges. One or more of the nodes can correspond to (e.g., include) information that is associated with at least one respective data object. In some embodiments, at least one of the directed edges corresponds to one or more hierarchical relationships among a plurality of the nodes. The object database can store a plurality of the data objects. The data objects may have a corresponding object class and/or object attribute. In some embodiments, one or more hierarchical relationships may exist among a subset of the plurality of data objects and/or may be based on respective object classes. The plurality of data objects may include one or more custom unified field objects. One or more of the object field types and/or location-based fields may include a node associated with one or more nodes corresponding to respective of the one or more custom unified field objects.

In some embodiments, the system may determine that a user should have access to the one or more second interfaces. This determination may be based on one or more data access rules. For example, the access rules may include providing access credentials. In some embodiments, the system may determine that the user should not have access to the one or more first interfaces based on the one or more data access rules.

In some instances, a computing system can automatically generate, based on a custom unified field object (e.g., received from a user), a plurality of interfaces for adding unified field objects (e.g., database entries, rows, documents, files, etc.) corresponding to one or more target or trigger data objects.

In some instances, an automatically generated example interface can include a no-code graphical user interface (e.g., web form, etc.) for creating, reading, updating, or deleting data associated with the custom unified field objects. An example graphical user interface for creating or updating data can include, for example, an object field type selector associated with each field of the custom unified field object. In some instances, each object field type selector can have a type that may depend on a data type associated with a corresponding field (e.g., text box for string field; calendar input for date field; check box for Boolean field; etc.). An example graphical user interface for reading, updating, or deleting data can include, for example, a data display component (e.g., table, spreadsheet, graph, text display component, etc.) for displaying one or more unified field objects and one or more action components or input components (e.g., buttons, text boxes, etc.) for interacting with the unified field objects (e.g., updating, deleting, etc.).

In some instances, the computing system can generate, based on the custom unified field object and/or custom unified field objects, one or more interfaces (e.g., no-code or low-code graphical user interfaces, etc.) for defining a custom unified field object associated with the custom unified field object and/or rule. For example, a user can define a name, logo, system name, permissions data, and/or other data associated with the custom unified field object.

Example implementations of the present disclosure can be implemented in the context of or as a portion of an employment management platform that controls and leverages organizational data to manage organizational applications such as payroll, operations, human resources (e.g., onboarding and/or offboarding), benefits, information technology and device management, third-party application integration and access, and/or many others.

The employment management platform can hold, for each of one or more organizations, a centralized set of organizational data that acts as a single, centralized system of record for all organizational management processes for that organization. Each organization can include a number of users which are able to access and interact with the employment management platform. Some users may have administrative permissions which define whether the user is able to access and/or modify certain types of organizational data for their organization.

The employment data for each location can include data directly entered into the employment management platform and/or can include data retrieved, pulled, or otherwise obtained from one or more first party and/or third-party applications with which the employment management platform may have varying levels of integration. This ingestion and storage of data from third-party applications is in contrast to systems which simply sit on top of third-party applications and apply rules at run time. In some implementations, the employment management platform can provide a user with the ability (e.g., by configuring Simple Mail Transfer Protocol (SMTP) settings) to configure the cadence or periodicity at which the employment management platform receives or ingests data (e.g., via .csv files) from third-party applications. Data can be transferred between the employment management platform and third-party applications (e.g., to and/or from) using various techniques such as application programming interfaces, data hooks, flat files, bulk uploads/downloads and/or other data transfer mechanisms.

The employment data can, in some implementations, be held as and/or in one or more object databases (e.g., in the form of one or more object graph data structures). For example, multiple object classes can be defined in the object databases. Example object classes include employees, devices, job candidates, benefits policies, documents, pay instances, timecards, and/or other objects. For each object, values can be provided and maintained for one or more attributes, such as location, role, etc. Links can be made between different objects. For example, one or more device objects can be associated with employee objects.

The object database(s) can be represented as and/or can store data which can be represented as one or more graphs with nodes that correspond to objects (e.g., data objects) and edges that correspond to links or logical associations between objects and/or object attribute(s). Graph(s) can be traversed to understand or leverage relationships among objects (e.g., data objects) and their attribute(s). In one example, the employment data can be synthesized into a single graph which includes multiple classes of objects and defines complex relationships among objects and their attribute(s). For example, all workflows, including payroll, IT, etc. can be run through one platform and graph. In some implementations, the employee objects can be referred to and/or treated as sentinel nodes. Traversal of the object graph(s) can be based at least in part on the object classes associated with the relevant data objects.

In some implementations, the employment data can include employment structure data. For example, the employment structure data can be encoded within links or edges defined between objects (e.g., data objects) of the employment data or can be stored as a separate data layer. For example, the employment structure data can define organizational relationships between objects, including employee objects. As one example, the employment structure data may indicate that a first employee object has the relationship of “manager” relative to a second employee object. The organizational relationships can be defined between specific objects and/or groups of objects. As another example, the employment structure data may indicate that a first group of employees (e.g., the “IT Administrator” group of employees) has a certain set of permissions (e.g., device activation/deactivation) relative to a particular group of devices (e.g., the “work laptops” group of the devices). Employment structure data may include relationships indicating, for each or a plurality of employees, one or more organizational groups (e.g., roles, departments, project teams, etc.) the employee belongs to.

Example implementations of the present disclosure can leverage a domain-specific query language (e.g., custom query language that is different from a standard query language such as Structured Query Language) that can be used to perform (e.g., in real time) queries against the employment data. The custom query language can be used to define functions (e.g., operators, formulas, etc.) or queries which return data that satisfies or responds to the functions or queries. In some implementations, the custom query language is a declarative language. In some implementations, the custom query language includes organization functions or operators which leverage organizational relationships within the employment data. For example, the organization function ORG(employee, relationship) can return one or more other employees that have the specified relationship to the specified employee. In some instances, the custom query language can include one or more formula functions (e.g., sum, average, standard deviation, count, etc.). In some instances, a unified field object can include a formula field, which can be automatically determined based on a formula comprising one or more other fields (e.g., employee's revenue total can be a sum of project revenues for all projects associated with employee, etc.). In some instances, an employment management platform can be configured so that formula fields can be automatically updated responsive to updates to one or more fields or other data the formula depends on. Such an automatic update can occur immediately after each update to the other data or fields, or can occur periodically (e.g., once per day, hour, week, etc.).

According to an aspect of the present disclosure, the custom query language can be incorporated into reports, policies, triggering, data management, and/or workflows. For example, a user-constructed query in the custom query language can be used for intelligently facilitating various downstream operations, for example, by reference/query to an employee or organizational chart.

The systems, methods, and computer program products described herein provide a number of technical effects and benefits. For example, some embodiments of the present disclosure can provide better scaling for large amounts of data compared to alternative systems and methods (e.g., alternative employment management platforms, etc.). For example, some embodiments of the present disclosure can provide SQL-like or relational-database-like functionality in a noSQL data storage format (e.g., MongoDB document store, etc.), which can in some instances be more scalable than a similar relational database. Additionally, some embodiments can include a language-agnostic or database-agnostic custom query language, which can act as a wrapper for a lower-level data storage system or application. In this manner, for instance, obsolete or legacy data storage systems can be substituted out, and more efficient or scalable new data storage systems can be substituted in as they become available, thereby increasing an efficiency of a computing system itself.

As another example, some embodiments of the present disclosure can provide better performance (e.g., lower latency, higher throughput, reduced processing power, reduced memory usage, etc.) compared to alternative systems and methods. For example, some embodiments of the present disclosure can provide asynchronous bulk updates in a noSQL format, which can be associated with lower latency, higher throughput, and lower cost compared to alternate systems and methods for updating a large number of unified field objects. Additionally, systems and methods of the present disclosure can provide query planning and data retrieval optimization tools for systems (e.g., noSQL document stores, etc.) that may otherwise lack robust data retrieval optimization tools. In this manner, for instance, a cost of creating, reading, updating, and deleting unified field objects can be reduced, thereby improving the functioning of a computing system itself.

As another example, the embodiments described in the present disclosure provide custom unified field object, custom unified field objects, and/or user interface creation, for example, more efficiently and with fewer computing resources (e.g., less processing power, less memory usage, less power consumption, etc.), than would otherwise be wasted by maintaining custom, proprietary, and/or manual processes. For example, some embodiments of the present disclosure can provide multiple interfaces, including a plurality of default graphical user interfaces, specific to a new custom unified field object and/or object field, while only adding a definition of the custom unified field object in computer memory or disk space. In some instances, additional graphical user interfaces can be provided while only storing a configuration or definition of the additional graphical user interfaces in computer memory or disk space. In some instances, a custom unified field object and/or custom unified field objects or graphical user interface definition can be stored using less than one kilobyte of space. In contrast, alternative systems and methods for providing a plurality of graphical user interfaces for a particular custom unified field object and/or custom unified field objects and any associated rule(s) may require separately creating (e.g., by a computer programmer, which can be a labor-intensive process) and storing substantial amounts of computer code for each custom interface associated with each custom unified field object and/or custom unified field objects. In this manner, for instance, example embodiments can provide custom unified field object development at a reduced computational cost (e.g., reduced memory cost) compared to any alternative methods.

With reference to the Figures, example embodiments of the present disclosure will be discussed in further detail.

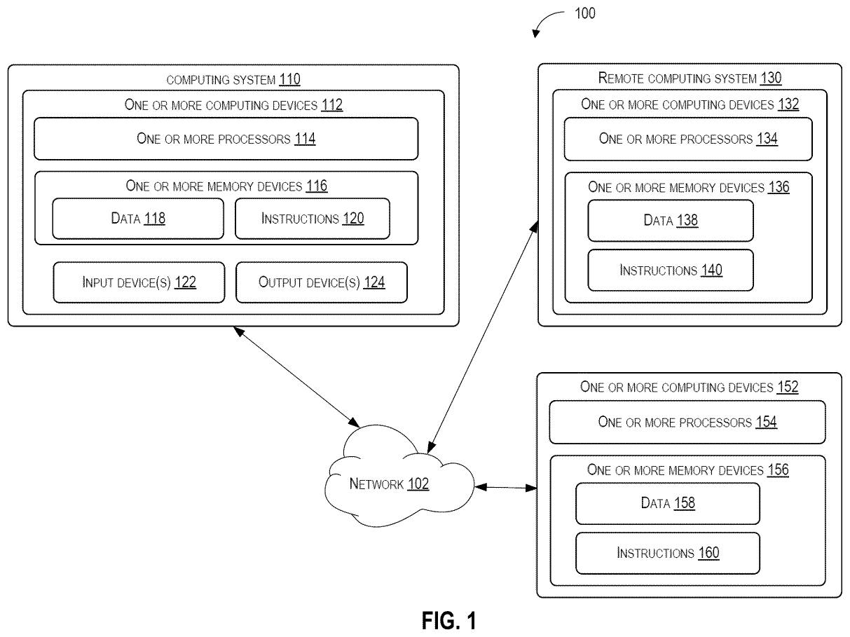

FIG. 1 depicts a block diagram of an example environment 100 including a computing system 110 that performs operations according to example embodiments of the present disclosure. The environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the internet. Further, the network 102 can include any number of wired or wireless connections and/or links that can be used to communicate with one or more computing systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems (not shown) and/or one or more computing devices 112. Further, the computing system 110 may be connected (e.g., networked) to one or more computing systems (e.g., remote computing system 130) and/or one or more computing devices (e.g., one or more computing devices 132, one or more computing devices 152, etc.) via the network 102. The computing system 110 may operate in various different configurations including as a server or a client machine in a client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes the one or more computing devices 112. The one or more computing devices 112 can include any type of computing device. For example, the one or more computing devices 112 can include a personal computing device (e.g., a desktop computing device), a mobile computing device (e.g., a smartphone or tablet device), a wearable computing device (e.g., a smartwatch device), an embedded computing device, a web appliance, a server computing device, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can include any processing device (e.g., a processor core, a microprocessor, an ASIC, a FPGA, a controller, or a microcontroller) and can include one processor or multiple processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random-access memory (RAM), read-only memory (ROM), EEPROM, EPROM, one or more flash memory devices, and/or one or more magnetic storage devices (e.g., one or more hard disk drives).

The one or more processors 114 can be configured to execute one or more instructions to perform the operations described herein including, for example, one or more operations associated with no-code application development and user interface customization across various types of applications and/or computer systems. Further, the one or more memory devices 116 can store the data 118 and/or the instructions 120, which can be executed by the one or more processors 114 to cause the one or more computing devices 112 to perform one or more operations.

In one example embodiment, the one or more operations that can be performed by the one or more processors 114 can include, but are not limited to: receiving a rule and a content item associated with a trigger, the rule having a condition for activation of the trigger; determining based on an evaluation of the object graph that the condition for activation of the trigger is satisfied; identifying, based on the determination that the condition for activation of the trigger is satisfied, a trigger data object associated with the trigger; and causing the content item to be transmitted to or displayed at a computing system associated with the trigger data object based on the identification of the trigger data object and on the determination that the condition for activation of the trigger is satisfied. In another example embodiment, the one or more operations that can be performed by the one or more processors 114 can include any operation discussed below.

The data 118 can include employment data (e.g., employment data that can include one or more organizational records), one or more data structures defining, describing, and/or otherwise associated with the employment data, rule data (e.g., rule data that includes one or more rules used to configure an application policy, one or more rules maintained by or otherwise associated with an employment data management system, etc.), application data (e.g., application data associated with a plurality of applications including one or more third-party applications and/or one or more intra-organizational applications), third-party integration data (e.g., data providing configuration and/or other information for performing integration and synchronization with each of one or more different third-party systems and/or applications), organizational policy data (e.g., organizational policy data associated with one or more organizational policies), application policy data (e.g., policy data that includes one or policies associated with the employment data, the rule data, the application data, one or more applications, one or more devices, etc.), data that includes instructions in a custom computer language (e.g., the above-described custom query language based on employment data), data that includes rules associated with the custom computer language, and/or other types of data. Further, the instructions 120 can include one or more instructions to use data including the data 118 to perform any one or more of the various operations described herein. In some embodiments, the one or more memory devices 116 can be used to store one or more applications that can be operated by the one or more processors 114. The data 118, the instructions 120, and/or the one or more applications can be associated with an organization. Further, the computing system 110 may be associated with an organization and may be configured to manage the one or more applications. For example, the computing system 110 can perform one or more operations associated with authenticating one or more users that attempt to access the one or more applications which can include one or more third-party applications, which may be remote from the computing system 110.

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more buttons, one or more microphones, and/or one or more cameras. The one or more output devices 124 can include one or more display devices, one or more loudspeaker devices, one or more haptic output devices. By way of example, the one or more output devices 124 can be used to display a graphical user interface via a display device that can include a touch screen layer that is configured to detect one or more inputs (e.g., one or more user inputs). The one or more processors 114 may perform one or more operations (e.g., operations associated with providing triggers based on one-to-many and/or many-to-one relationships between entities and/or data objects in a system of record) based at least in part on the one or more inputs.

The remote computing system 130 includes the one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110. Further, the remote computing system 130 can communicate with one or more devices and/or one or more systems via the network 102.

In some embodiments, the remote computing system 130 can include one or more applications (e.g., computer software applications comprising computer instructions) that can be stored and/or executed by the remote computing system 130. Further, the one or more applications can include one or more third-party applications that may be accessed from the computing system 110 and which are at least partly operated from the remote computing system 130. The one or more third-party applications generally may be associated with and provided by an organization that is different from the organization that is associated with the computing system 110. Further, the data 138 can include one or more portions of the employment data (e.g., one or more organizational records), one or more data structures associated with the employment data, rule data, organizational policy data, application policy data, third-party integration data, application object data, and/or other types of data.

One or more computing devices 152 (e.g., user devices or any other types of devices) can include one or more processors 154, one or more memory devices 156, the data 158, and/or the instructions 160. Such one or more computing devices 152 may include any of the attributes and/or capabilities of the one or more computing devices 112, 132. Further, such one or more computing devices 152 can communicate with one or more devices and/or one or more systems via the network 102.

In some embodiments, the one or more computing devices 152 can include one or more applications (e.g., computer software applications comprising computer instructions) that can be stored and/or executed by such one or more computing devices 152. Further, the one or more applications can include one or more third-party applications that may be accessed from the one or more computing devices 152 and which are at least partly operated from such one or more computing devices 152. Data 138 may include, for example, one or more portions of the employment data (e.g., one or more organizational records), one or more data structures associated with the employment data, rule data, organizational policy data, application policy data, third-party integration data (e.g., third-party application integration data), application object data, and/or other types of data.

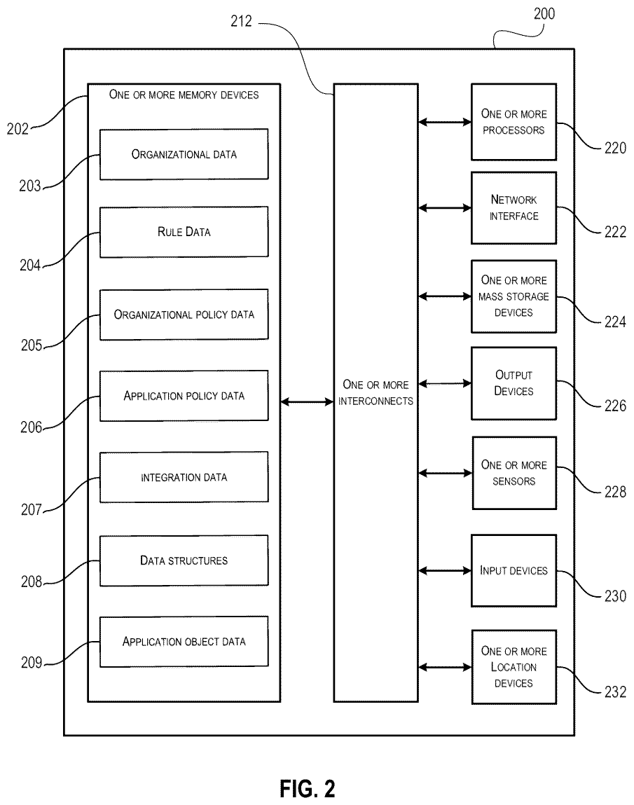

FIG. 2 depicts a block diagram of an example computing device 200 according to example embodiments of the present disclosure. The computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, employment data 203, rule data 204, organizational policy data 205, application policy data 206, integration data 207, data structures 208, application object data 209, one or more interconnects 212, one or more processors 220, a network interface 222, one or more mass storage devices 224, one or more output devices 226, one or more sensors 228, one or more input devices 230, and/or one or more location devices 232.

The one or more memory devices 202 can store information and/or data (e.g., employment data 203, rule data 204, organizational policy data 205, application policy data 206, integration data 207, data structures 208, application object data 209, and/or any other types of data). Further, the one or more memory devices 202 can include one or more non-transitory computer-readable storage media, including RAM, ROM, EEPROM, EPROM, flash memory devices, magnetic disks, and any combination thereof.

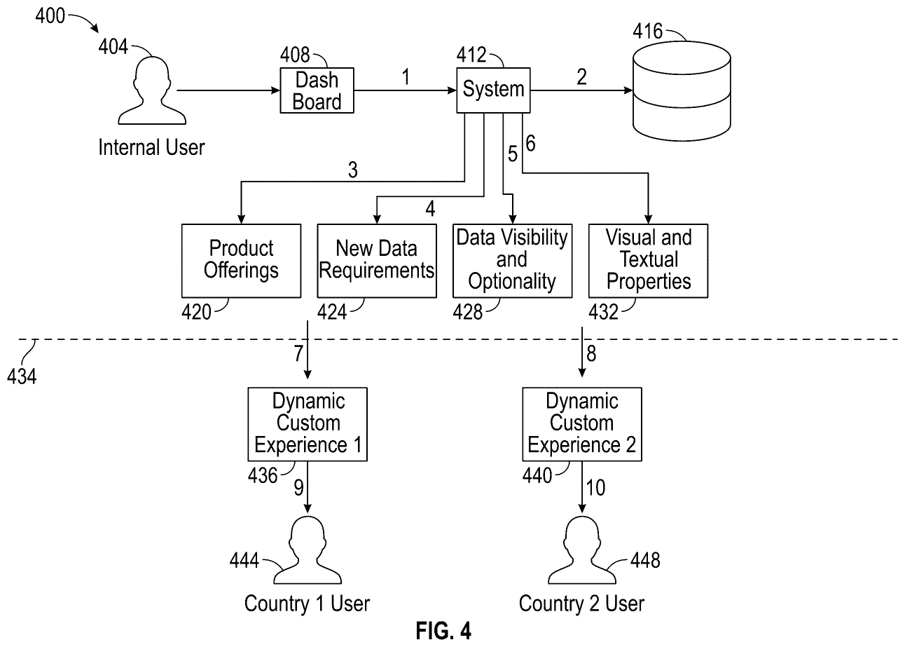

In one example embodiment, the information and/or data that can be stored by the one or more memory devices 202 can be executed by the one or more processors 220 to cause the computing device 200 to perform one or more operations associated with receiving a custom unified field object, custom unified field object, and/or custom rule definition via one or more interfaces (e.g., as described below with respect to FIGS. 4-9F).

In another example embodiment, the information and/or data that can be stored by the one or more memory devices 202 can be executed by the one or more processors 220 to cause the computing device 200 to perform one or more operations associated with defining a custom unified field object or custom audience of data objects associated with one or more rules and/or triggers.

The employment data 203 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The employment data 203 also can include information associated with one or more applications (e.g., one or more third-party applications), one or more organizational records and/or one or more organizational policies. In some embodiments, the employment data 203 can be received from one or more computing systems (e.g., the remote computing system 130 depicted in FIG. 1) which can include one or more computing systems that are remote (e.g., in another room, building, part of town, city, or nation) from the computing device 200.

The rule data 204 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The rule data 204 can include information associated with one or more rules that can be used to generate and/or implement an application policy. The rule data 204 also can include information associated with one or more rules of an employment data management system (e.g., base or default rules provided or enforced by the system, one or more custom rules configured by an organization, etc.). The rule data 204 also can include one or more rules associated with implementing and/or utilizing a custom computer language, such as a custom computer language (e.g., the above-described custom query language) for performing operations associated with employment data 203. In some embodiments, the rule data 204 can be received from one or more computing systems (e.g., the remote computing system 130 depicted in FIG. 1), which can include one or more computing systems that are remote from the computing device 200.

The organizational policy data 205 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Furthermore, the organizational policy data 205 can include information associated with one or more organizational policies that are used to regulate one or more applications (e.g., one or more third-party applications), one or more computing devices, and/or one or more records which can include one or more organizational records and/or one or more employee records. In some embodiments, the organizational policy data 205 can be received from one or more computing systems (e.g., the remote computing system 130 depicted in FIG. 1) which can include one or more computing systems that are remote from the computing device 200.

The application policy data 206 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Furthermore, the application policy data 206 can include information associated with one or more policies that are used to implement an application policy associated with one or more applications (e.g., one or more third-party applications), one or more computing devices, and/or one or more records which can include one or more organizational records and/or one or more employee records. In some embodiments, the application policy data 206 can be received from one or more computing systems (e.g., the remote computing system 130 depicted in FIG. 1) which can include one or more computing systems that are remote from the computing device 200.

The integration data 207 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The integration data 207 can include configuration and/or operational information associated with integrating and synchronizing data (e.g., employment data 203) among one or more applications. For example, the integration data 207 can include information that enables integration and synchronization between each of one or more applications (e.g., third-party applications and/or other applications). In an embodiment, the integration data 207 provides integration information that allows an employment data management system (e.g., a system of record for employment data and employment data processing), for example: to obtain information from one or more applications (e.g., third party and/or other applications); to perform operations involving employment data (e.g., employment data 203) in the employment data management system; to synchronize employment data across one or more applications; to perform one or more actions involving the applications based on employment data in the employment data management system; and/or to perform one or more other operations associated with managing employment data as a system of record. In some embodiments, the integration data 207 can be received from one or more computing systems (e.g., the remote computing system 130 depicted in FIG. 1), which can include one or more computing systems that are remote from the computing device 200.

The data structures 208 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The data structures 208 can include one or more logical and/or physical instances of information representing or describing, for example: one or more entities (e.g., objects (e.g., data objects), records, etc.); one or more relationships involving the one or more entities (e.g., relationships between entities); one or more data values associated with each of the one or more entities and/or the one or more relationships; one or more functions and/or operations that may be applied to each of the one or more entities and/or the one or more relationships; and/or any other data or metadata describing or otherwise defining structure and/or rules associated with the one or more entities and/or the one or more relationships.

The data structures 208 can be implemented and utilized with one or more types of computer software, computer hardware, or any combination thereof. In an embodiment, the data structures 208 are used to represent and perform processing associated with various types of employment data (e.g., employment data 203). For example, the data structures 208 may include information about various types of information and entities associated with employment data including, but not limited to, individuals (e.g., employees, vendors, independent contractors, etc.), departments, teams, roles, groups, locations, offices, documents, tasks, reports, accounts, devices, applications, end-user applications, licenses, workflows, alerts, and/or any other type of entity representing or related to managing employment data (e.g., employment data 203).

The data structures 208 also can define various relationships among the various entities associated with employment data. Additionally or alternatively, the relationships may be based on the object class associated with various associated data objects. For example, the data structures 208 may define and be used to enforce relationships such as, for instance: each employee must be assigned to a department; each employee can be included on one or more teams; each employee must be assigned to a primary location; each employee may be assigned to one or more secondary locations; employees may have one or more computing devices; each vendor must have a current audit; each independent contractor must be associated with a contract; and/or any other relationships provided by an employment data management system or configured for an organization that utilizes an employment data management system (e.g., a system for managing employment data 203 based on one or more employment data management applications).

In some embodiments, the data structures 208 can include one or more object graphs (e.g., based on an object graph data model) providing information about entities, relationships, and/or any other aspects relating to the definition, structure, and rules associated with employment data (e.g., employment data 203). The data structures 208 also can include any one or more other types of data structures (e.g., with or without the use of object graphs) that provide information about entities, entity attributes, entity attribute categories, relationships, and/or any other aspects of the definition, structure, and/or rules associated with employment data. In some embodiments, the data structures 208 can be received from one or more computing systems (e.g., the remote computing system 130 depicted in FIG. 1), which can include one or more computing systems that are remote from the computing device 200.

The application object data 209 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Furthermore, the application object data 209 generally can include any information used to implement any particular type of application object or associated data structure that stores, references, utilizes, and/or processes data (e.g., employment data 203). For example, such types of application objects generally may include, but are not limited to, application triggers, reports, workflows, tasks, custom application objects, and/or any other types of objects used to store and/or process data in a system of record, such as an employment data management system. Further, application object data 209 that can be used to implement any particular type of application object or associated data structure may include, but is not limited to: instructions in a computer language (e.g., a custom computer language provided by an employment data management system for managing employment data 203); metadata associated with application objects or related data structures; data associated with one or more particular instances of application objects or related data structures; data associated with configuration of one or more application objects or related data structures; and/or other data that can be used to implement any particular type of application object or associated data structure. In some embodiments, the application object data 209 can be received from one or more computing systems (e.g., the remote computing system 130 depicted in FIG. 1) which can include one or more computing systems that are remote from the computing device 200.

The one or more interconnects 212 can include one or more interconnects or buses that can be used to send and/or receive one or more signals (e.g., electronic signals) and/or data (e.g., employment data 203, rule data 204, organizational policy data 205, application policy data 206, integration data 207, data structures 208, application object data 209, and/or any other data) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the one or more location devices 232. The one or more interconnects 212 can be arranged or configured in different ways. For example, the one or more interconnects 212 can be configured as parallel or serial connections. Further, the one or more interconnects 212 can include one or more internal buses that are used to connect the internal components of the computing device 200 and one or more external buses used to connect the internal components of the computing device 200 to one or more external devices. By way of example, the one or more interconnects 212 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the employment data 203, the rule data 204, the organizational policy data 205, the application policy data 206, the integration data 207, the data structures 208, the application object data 209, and/or any other data. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the internet). For example, the network interface 222 can allow the computing device 200 to communicate with the computing system 110 via the network 102.

The one or more mass storage devices 224 (e.g., a hard disk drive and/or a solid-state drive) can be used to store data including the employment data 203, the rule data 204, the organizational policy data 205, the application policy data 206, the integration data 207, the data structures 208, the application object data 209, and/or any other data. The one or more output devices 226 can include one or more display devices (e.g., liquid crystal display (LCD), OLED display, mini-LED display, micro-LED display, plasma display, and/or cathode ray tube (CRT) display), one or more light sources (e.g., LEDs), one or more loudspeakers, and/or one or more haptic output devices (e.g., one or more devices that are configured to generate vibratory output).

The one or more sensors 228 can be configured to detect various states and can include one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of invoking or performing one or more operations. For example, the one or more sensors 228 can be used to authenticate the identity of a user and determine an authorization level based on an image of the user's face that is captured using the one or more sensors 228.

The one or more input devices 230 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 200).

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, and/or network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications (e.g., one or more organizational applications and/or one or more third-party applications) that are subject to one or more application policies or utilize third-party integration data that can be configured, generated, and/or implemented by the computing device 200 and/or one or more other computing devices or one or more computing systems. In some embodiments, the one or more memory devices 202 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

The one or more location devices 232 can include one or more devices or circuitry for determining the position of the computing device 200. For example, the one or more location devices 232 can determine an actual and/or relative position of the computing device 200 by using a satellite navigation positioning system (e.g. a GPS system, a Galileo positioning system, the GLObal Navigation satellite system (GLONASS), the BeiDou Satellite Navigation and Positioning system, an inertial navigation system, a dead reckoning system, based on IP address, by using triangulation and/or proximity to cellular towers or Wi-Fi hotspots, and/or beacons.

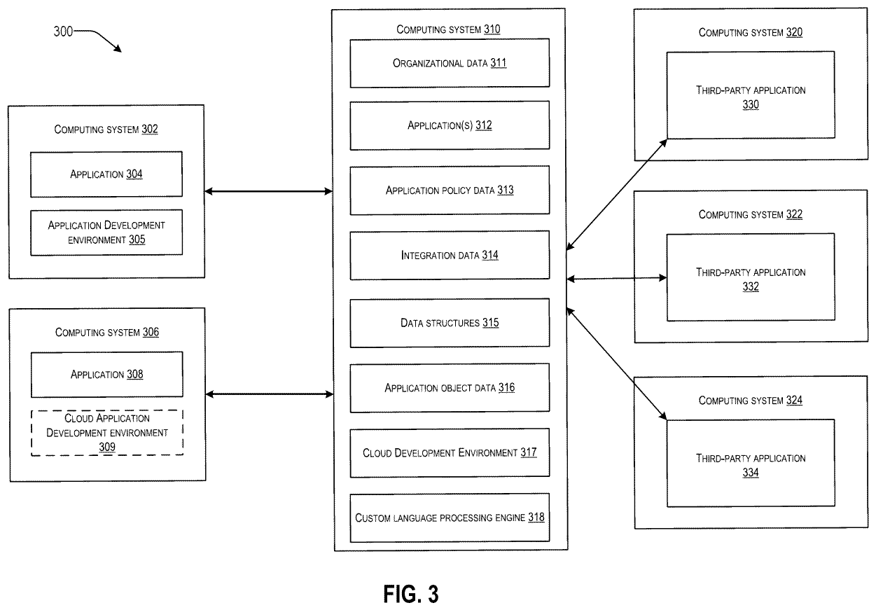

FIG. 3 depicts a block diagram of an example computing environment 300 including multiple computing systems, according to example embodiments of the present disclosure. Any of computing system 302, computing system 306, computing system 310, computing system 320, computing system 322, or computing system 324 can include one or more attributes and/or capabilities of the computing system 110, the remote computing system 130, the one or more computing devices 152, and/or the computing device 200. Furthermore, any of the computing system 302, the computing system 306, the computing system 310, the computing system 320, the computing system 322, or the computing system 324 can be configured to perform one or more operations and/or one or more actions that can be performed by the computing system 110, the remote computing system 130, the one or more computing devices 152, and/or the computing device 200.

As shown in FIG. 3, the example computing environment 300 includes the computing system 302, an application 304, an application development environment 305, the computing system 306, an application 308, a cloud application development environment 309, the computing system 310, employment data 311 (e.g., employment data 203), one or more application(s) 312, an application policy data 313, integration data 314, data structures 315, application object data 316, a cloud development environment 317, a custom language processing engine 318, the computing system 320, the computing system 322, the computing system 324, a third-party application 330, a third-party application 332, and a third-party application 334.

In an embodiment, the computing system 302, the computing system 306, the computing system 310, the computing system 320, the computing system 322, and/or the computing system(s) 324 can be configured to communicate directly and/or via a communication network (e.g., the network 102 depicted in FIG. 1). In one embodiment, the computing system 302 includes an application 304 that is stored and/or operates on the computing system 302 and can communicate (e.g., send and/or receive data and/or information) with one or more other computing systems including the computing system 306 and/or the computing system 310. The application 304 can, for example, include an email application that performs one or more operations on the computing system 302 and includes an email account associated with an organizational record (e.g., an employee record including the name of an employee, an email access identifier, and an email passcode) that is stored as part of the employment data 311. In an example, a user associated with the computing system 302, the computing system 306, and/or the computing system 310 can use a portion of the employment data 311 associated with their employee record to access a corresponding account associated with one or more of application 304, application 308, and/or application(s) 312.

In an embodiment, one or more application(s) 312 provide access to, utilize, support, and/or otherwise provide various interfaces or services that enable other applications (e.g., application 304, application development environment 305, application 308, cloud application development environment 309, application(s) 312) and/or users to perform various operations and activities involving one or more custom computer languages. For example, a custom computer language (e.g., a custom query language) generally may provide users with a simplified set of computer instructions that align with or match a user's understanding of a functional or business environment, such as an organization, business, industry, sector, and/or another functional or business environment. In some embodiments, each of such one or more custom computer languages is a user language that allows users with a basic understanding of, for instance, a subject, topic, business area, organization, functional role, industry, sector, etc. to implement custom computer instructions in terms that are familiar to the users, without knowledge of a complex computer programming language, without dependence on computer programmers, without being aware of or needing to know the complexity of underlying data organization and storage, without needing to understand, implement, and/or maintain a complex web of join conditions across various sets of underlying data, etc.

In an embodiment, a custom computer language generally enables users of any skill or level with a basic knowledge of a subject area to perform one or more operations or activities associated with an application (e.g., any of applications 312). For example, a custom computer language generally may enable a user to create, update, execute, and/or otherwise implement custom queries, reports, policies, workflows, triggers, and/or other functionality and operations associated with an application. In some embodiments, a custom computer language enables a user to utilize and perform various operations involving employment data 311. For example, one or more applications associated with an employment data management system or any other types of applications (e.g., applications 312) generally may provide a custom computer language allowing users to perform operations based on the structure and/or relationships associated with employment data 311.

In an embodiment, a custom computer language may allow a user to use simplified terms to query employment data 311. In one example, a custom computer language may allow a user to obtain the name of an employee's manager with the following example query: “ORG(John Smith, Manager)”, which may return “Jane Jones” as the manager of the employee. As such, a custom computer language for an application may allow a user to use simplified and familiar terms without needing to understand complex interrelationships between various types of data stored across one or more different databases and/or other types of data stores. Further, a custom computer language generally may be processed by one or more applications (e.g., application(s) 312 associated with an employment data store) so that users do not have to specify data joins when performing various operations involving employment data 311.

In an embodiment, a custom computer language (e.g., a custom query language) includes a function that reports quantile information based on employee information or any other type of employment data. For example, such a function generally may be labeled as a “quantile” function, as a “percentile” function, or given any other type of label or name. The following examples generally refer to the function name as “quantile” for illustration purposes only.

In an example, a “quantile” function of a custom query language generally may return a particular quantile (e.g., decile, percentile, etc.) of employment data (e.g., an employee, a department, etc.) in comparison to other corresponding employment data (e.g., other employees, other departments, etc.). In one example, a “quantile” function call in a custom query language may take four arguments. For example, a first example argument of the “quantile” function may specify a particular instance of employment data 311 such as a particular employee, a particular department, a particular contractor, a particular vendor, or any other particular instance of employment data 311. A second example argument of the “quantile” function may specify a numeric attribute value, a derived value, or a calculated value for comparison. A third example argument of the “quantile” function may specify a logical condition that evaluates to “true” or “false” for corresponding employment data (e.g., other employees, other departments, etc.) where the corresponding employment data that evaluates to “true” is included when calculating quantile information. As such, corresponding employment data that evaluates to “false” would not be included when calculating quantile information. A fourth example argument of the “quantile” function may specify a particular quantile to use for analysis. For example, the example fourth argument may specify a numeric value representing a number of buckets to use for calculating a particular quantile (e.g., the value “4” for quartiles, the value “5” for quintiles, the value “10” for deciles, the value “100” for percentiles and/or any other value for calculating a particular, specialized quantile associated with employment data 311). The example fourth argument also could take text input indicating a particular type of quantile to utilize (e.g., “quartile”, “quintile”, “decile”, “percentile”, etc.) and is not limited to numeric values.

In one example, a signature of an example “quantile” function of a custom computer language (e.g., a custom query language) generally can be defined and/or appear as “QUANTILE({employee_information}, {attribute_value_to_compare}, {logical_condition, quantile_type)}”. For example, an example call to the “quantile” function of the custom query language generally may be invoked based on the following example custom query language statement: “QUANTILE(“Denise Smith”, role, level=$level, 10). In the example quantile function call, the first example argument specifies the name of a particular employee or individual. Other values, such as a unique employee identifier, unique contractor identifier, and/or any other type of unique identifier of a particular instance of employment data may be utilized (e.g., unique department name, unique department id, etc.).

The second example argument in the example quantile function call indicates role as the attribute of the specified employee (i.e., “Denise Smith”) to be compared. Also, any derived or calculated values, such as “TODAY( )-employee_start_date” (e.g., which calculates an employee's length of employment) may be utilized. The third example argument in the example quantile function call indicates a logical condition where the level of other employees “level” is equal “=” to the level of “Denise Smith” “$level”. As such, employees at the same level as “Denise Smith” in an employment data management system as indicated by the employment data will be included in the QUANTILE determination of the current example. The fourth example argument in the example quantile function call “10” indicates that 10 quantiles (i.e., “deciles”) are to be used in the calculation of determining how “Denise Smith's” “role” compares to other employees at the same level (i.e., “level=$level”). Thus, “Denise Smith” may fall into any one of 10 buckets depending on how her “role” compares to other employees in an organization based on employment data 311.

The example QUANTILE function generally can return the number of the particular, specified quantile (e.g., the bucket number) based on a determination. Continuing with the current example, if “Denise Smith” had “role” that ranked in the top ten percent of employees at the same level (i.e., “level=$level”) then “10” would be returned as the determined decile bucket of the example quantile function (or, for example if quartiles were specified instead of deciles, then “4” would be returned). Similarly, if the “role” of “Denise Smith” ranked last in the determination, then a “1” would be returned as the determined decile bucket of the example quantile function (“1” also would be returned if quartiles were specified instead of quintiles). In an additional example, a custom query language statement: “QUANTILE(“Denise Smith”, equity grant, start_date<$start_date+90 and start_date >$start_date−90 and equity_grant>0, 100) returns “Denise Smith's” “equity grant” decile in comparison to other employees with start dates within 90 days of “Denise Smith's” start date where those employees have equity grants.

In an embodiment, a custom computer language is based on and/or otherwise associated with one or more data structures 315 associated with an application. For example, a custom computer language may be based on, represent, describe, or otherwise be associated with an object graph data structure (e.g., a master object graph, any one or more portions of a master object graph, etc.) and/or any other types of data structures 315 that describe the structure of an application and/or the underlying data associated with an application. In an example, a custom computer language is based on the structure of one or more applications and/or associated employment data 311 of an employment data management system. For example, the structure of the one or more applications and/or the associated employment data 311 may be represented and described in one or more data structures 315 including, but not limited to, one or more independent and/or interrelated object graph data structures. In various embodiments, an application (e.g., one of application 312) and/or another supporting application used in association with the application can utilize one or more data structures 315 including, for instance, one or more object graph data structures to process and perform various underlying operations associated with custom computer language instructions.

In an embodiment, the computing system 302 includes an application development environment 305 that provides users with access to and/or operations associated with one or more computer languages including, but not limited to, a custom computer language. For example, the application development environment 305 can be associated with one or more applications of an employment data management system that stores and manages various types of employment data 311. In an example, application development environment 305 generally may be an application (e.g., application 304) or portion of an application that enables a user to perform various operations involving employment data 311 of an employment data management system using a custom computer language. For example, application development environment 305 generally may enable a user to create, update, execute, and/or otherwise implement custom queries, reports, policies, workflows, triggers, rules, group assignments, content items, data objects, audiences, and/or other functionality and operations associated with one or more applications of an employment data management system.

In various embodiments, any one or more parts of the application development environment 305 may run, for example, on a computing system (e.g., computing system 302) and/or in association with information, applications, and/or services on another computing system (e.g., computing system 310). For example, application development environment 305 may utilize employment data 311, application(s) 312, application policy data 313, integration data 314, data structures 315, and/or application object data 316 available from another computing system (e.g., computing system 310, one or more computing systems associated with an employment data management system, etc.). In at least one embodiment of the present disclosure, application development environment 305 can include specialized computer software for performing operations associated with providing and/or implementing triggers based on one-to-many and/or many-to-one relationships between entities and/or data objects in a system of record, where such specialized computer software and/or such operations associated with providing and/or implementing such triggers can be based on computer instructions in a custom computer language provided by the system of record. For example, in one embodiment, application development environment 305 also can include a query processing engine (not shown), computer instruction compiler (not shown), computer instruction generator (not shown), and/or other specialized computer software for performing operations associated with providing and/or implementing triggers based on one-to-many and/or many-to-one relationships between entities and/or data objects in a system of record (e.g., where such specialized computer software and/or such operations associated with providing and/or implementing such triggers can be based on computer instructions in a custom computer language provided by the system of record). Application development environment 305 also may utilize or work in conjunction with, in whole or in part, cloud development environment 317 and custom language processing engine 318 (e.g., including, for instance, any computer instruction compiler (not shown) and/or computer instruction generator (not shown) associated with custom language processing engine 318), and/or other features and/or operations available from another computing system (e.g., computing system 310, one or more computing systems associated with an employment data management system, etc.).

In an embodiment, application development environment 305 can include an editor that allows users to enter, define, edit, check, store, schedule, execute, and/or perform any other operations associated with creating, viewing, maintaining, and/or utilizing computer instructions in a custom computer language. In some embodiments, application development environment 305 includes a textual editor that enables users to enter and manipulate computing instructions in a custom computer language. In some examples, a textual editor of the application development environment 305 may assist users with constructing various types of statements in a custom computer language. For example, the textual editor may provide: syntax highlighting in a custom computer language; intelligent completion of keywords or statements in a custom computer language; automated hints and examples; various types of pop-up information to assist a user in writing or editing instructions in a custom language; visual notification of syntax or other errors; suggested correction of syntax or other errors; automatic suggestion and/or population of objects and/or functions; and/or other assistance with constructing various types of statements in a custom computer language. In some examples, automation and other assistance provided by a textual editor of the application development environment 305 may be based on and may actively utilize one or more data structures 315 (e.g., an object graph based on employment data 311) associated with implementation of a custom computer language.

In an embodiment, application development environment 305 can include a visual editor (e.g., either with or without a textual editor) to, for example, create, view, maintain, and/or utilize computer instructions in a custom computer language. For example, the visual editor may allow users to build, modify, and perform other operations associated with instructions in a custom computer language via drag and drop and/or any other types of graphical user interfaces (e.g., a software wizard or setup assistant user interface that presents a user with a sequence of dialog boxes or other types of interfaces that guide the user through a series of steps in generating one or more portions of an application). Further, a visual editor generally also may provide dropdown lists, enhanced browsing, and other visual access to features and operations of a custom computer language, and/or one or more data structures 315 associated with a custom computer language or related application to construct, edit, and/or otherwise utilize instructions in a custom computer language. In some examples, the application development environment 305 may provide a textual editor in combination with the visual editor to allow users to view, utilize, and alternate between both textual and visual editors of a custom query language, for example, as part of the same user interface. In some examples, application development environment 305 can parse and perform various operations involving instructions in a custom computer language alone or in association with another computing system (e.g., based on various data and/or services provided by computing system 310).

In an embodiment, the computing system 310 includes one or more application(s) 312 that can perform one or more operations on the computing system 310 and can communicate data and/or information with any one or more computing systems, including the computing system 302 and/or the computing system 306, or any one or more computing devices. The application(s) 312 can, for example, include an employee management application that operates on the computing system 310 and accesses the employment data 311, which can include one or more organizational records associated with the names of organization employees and the respective employment statuses for each of the employees (e.g., an employee's position or role within the organization, an organizational department associated with the employee, etc.). A user (e.g., a privileged user, such as a manager or administrator with the authority to access and/or modify the employment data 311) associated with the computing system 306 can, for example, access and/or modify the employment data 311 to reflect one or more events that can include, but are not limited to, for instance: when an employee receives a promotion or a raise; changes to a different department; is added to one or more new teams; is assigned new computer hardware or other equipment; and/or another event associated with the employee and/or another entity and/or data object of an organization.

The one or more application(s) 312 can perform one or more operations on the computing system 310 and can communicate data and/or information with one or more computing systems, including the computing system 302 and/or the computing system 306, or any one or more computing devices. The application(s) 312 can, for example, include an administrative or other type of system application to manage one or more aspects of the application(s) 312 including, but not limited to, installing, configuring, maintaining, updating, integrating, automating, and/or performing one or more other operations associated with the application(s) 312 on the computing system 310 and that can manage one or more aspects of one or more other applications on different systems and devices, which may include the application 304 and/or the application 308.

In some embodiments, the application(s) 312 can include one or more third-party applications that are stored and/or perform operations on the computing system 310. Further, the application(s) 312 can retrieve data and/or information associated with and/or operate in cooperation with applications external to the computing system 310 (e.g., the computing system 302 and/or the computing system 306). The application(s) 312 can also use (e.g., access, modify, and/or control) the employment data 311. For example, the application(s) 312 can use the employment data 311 that is associated with the application 304 to perform one or more operations using the application 308 that is on the computing system 306.

In an embodiment, the computing system 306 includes a cloud application development environment 309. For example, the cloud application development environment 309 generally may be a local instance of an online integrated development environment (e.g., a cloud development environment 317) provided by a computing system (e.g., computing system 310) that is accessed from a web browser and/or any other type of application 308 on another computing system (e.g., computing system 306). For example, the cloud application development environment 309 can be associated with one or more applications of an employment data management system that stores and manages various types of employment data 311. In an example, cloud application development environment 309 generally may be an application (e.g., application 308) or portion of an application that enables a user to perform various operations involving employment data 311 of an employment data management system using a custom computer language. For example, cloud application development environment 309 generally may enable a user to create, update, execute, and/or otherwise implement custom queries, reports, policies, workflows, triggers, rules, group assignments, audiences, content items, and/or other functionality and operations associated with one or more applications of an employment data management system.

In various embodiments, any one or more parts of the cloud application development environment 309 may run, for example, on a computing system (e.g., computing system 306) and/or in association with information, applications, and/or services on another computing system (e.g., computing system 310). For example, cloud application development environment 309 may utilize employment data 311, application(s) 312, application policy data 313, integration data 314, data structures 315 and/or application object data 316 available from another computing system (e.g., computing system 310, one or more computing systems associated with an employment data management system, etc.). In at least one embodiment of the present disclosure, cloud application development environment 309 can include specialized computer software for performing operations associated with providing and/or implementing triggers based on one-to-many and/or many-to-one relationships between entities and/or data objects in a system of record, where such specialized computer software and/or such operations associated with providing and/or implementing such triggers can be based on computer instructions in a custom computer language provided by the system of record. For example, in one embodiment, cloud application development environment 309 also can include a query processing engine (not shown), computer instruction compiler (not shown), computer instruction generator (not shown), and/or other specialized computer software for performing operations associated with providing and/or implementing triggers based on one-to-many and/or many-to-one relationships between entities and/or data objects in a system of record (e.g., where such specialized computer software and/or such operations associated with providing and/or implementing such triggers can be based on computer instructions in a custom computer language provided by the system of record). Cloud application development environment 309 also may utilize or work in conjunction with, in whole or in part, cloud development environment 317 and custom language processing engine 318 (e.g., including, for instance, any computer instruction compiler (not shown) and/or computer instruction generator (not shown) associated with custom language processing engine 318), and/or other features and or operations available from another computing system (e.g., computing system 310, one or more computing systems associated with an employment data management system, etc.).

In an embodiment, cloud application development environment 309 can include an editor that allows users to enter, define, edit, check, store, schedule, execute, and/or perform any other operations associated with creating, viewing, maintaining, and/or utilizing computer instructions in a custom computer language. In some embodiments, cloud application development environment 309 includes a textual editor that enables users to enter and manipulate computing instructions in a custom computer language. In some examples, a textual editor of the cloud application development environment 309 may assist users with constructing various types of statements in a custom computer language. For example, the textual editor may provide: syntax highlighting in a custom computer language; intelligent completion of keywords or statements in a custom computer language; automated hints and examples; various types of pop-up information to assist a user in writing or editing instructions in a custom language; visual notification of syntax or other errors; suggested correction of syntax or other errors; automatic suggestion and/or population of objects and/or functions; and/or other assistance with constructing various types of statements in a custom computer language. In some examples, automation and other assistance provided by a textual editor of the cloud application development environment 309 may be based on and may actively utilize one or more data structures 315 (e.g., an object graph based on employment data 311) associated with implementation of a custom computer language.

In an embodiment, cloud application development environment 309 can include a visual editor (e.g., either with or without a textual editor) to, for example, create, view, maintain, and/or utilize computer instructions in a custom computer language. For example, the visual editor may allow users to build, modify, and perform other operations associated with instructions in a custom computer language via a drag and drop and/or any other types of graphical user interfaces (e.g., a software wizard or setup assistant user interface that presents a user with a sequence of dialog boxes or other types of interfaces that guide the user through a series of steps in generating one or more portions of an application). Further, a visual editor generally also may provide dropdown lists, enhanced browsing, and other visual access to features and operations of a custom computer language, and/or one or more data structures 315 associated with a custom computer language or related application to construct, edit, and/or otherwise utilize instructions in a custom computer language. In some examples, the cloud application development environment 309 may provide a textual editor in combination with the visual editor to allow users to view, utilize, and alternate between both textual and visual editors of a custom query language, for example, as part of the same user interface.

The computing system 310 includes the application policy data 313 which can be implemented on the computing system 310 and can be used to perform one or more operations associated with implementing an application policy associated with the employment data 311 and/or one or more applications including the application 304, the application 308, and/or application(s) 312. The application 304, the application 308, and/or application(s) 312 can include one or more third-party applications that are separate from, that are operated separate and apart from, and that are not affiliated with the organization that manages, owns, controls, and/or maintains the employment data 311 or an associated employment data management application on the computing system 310, and/or that determines or implements an application policy associated with the application policy data 313. In one example, third-party applications can be differentiated from organizational applications that, for example, are inherent to, are a part of, or otherwise operate directly or as part of an employment data management application, system, services, and/or platform.

The application policy data 313 can include one or more rules that determine how one or more applications including, for example, one or more third-party applications or organizational applications are accessed, modified, and/or controlled. For example, the application policy data 313 can use the employment data 311 that is associated with the application 304 to perform one or more operations on the application(s) 312 and/or the application 308. Also, the application policy data 313 can use the employment data 311 that is associated with the application(s) 312 to perform one or more operations on the application 304 and/or the application 308. By way of further example, the application policy data 313 can use the employment data 311 that is associated with the application 308 to perform one or more operations on the application 304 and/or the application(s) 312. In some embodiments, the application policy data 313 can determine how a combination of one or more organizational applications and/or one or more third-party applications are accessed, modified, configured, and/or controlled. For instance, in these or other embodiments, the application policy data 313 can determine how one or more applications owned and controlled by an organization that owns and controls the employment data 311 and/or applications provided with or as part of an employment data management system used by the organization as a system of record for maintaining the employment data 311 are accessed, modified, configured, and/or controlled.

The computing system 310 includes the integration data 314, which can reside on the computing system 310 and can be used, for example, to perform one or more operations that integrate the employment data 311 and associated activities based on the employment data 311 across one or more different computing systems (e.g., such as computing system 302, computing system 306, and computing system 310) and/or applications (e.g., such as application 304, application 308, and application(s) 312). For example, the integration data 314 can be used to integrate and synchronize employment data 311 and/or associated operations across an employment data management application or system (e.g., a system of record for organization data 311) and each of one or more separate third-party applications that utilize employment data 311 and/or perform operations based on employment data 311.

In an embodiment, the integration data 314 can include configuration information associated with integrating and synchronizing data among one or more computing systems and/or applications. For example, the integration data 314 can include information that enables integration between an organizational application (e.g., an application 312 associated with an employment data management system of record for the employment data 311) and each of one or more separate third-party applications (e.g., application 304, application 308, etc.) that use or perform operations based on the employment data 311). In some embodiments, such integration data 314 may include, but is not limited to, information indicating and/or describing various data that enables performance of an integration between applications or systems such as, for instance: an integration type information (e.g., flat file, application programming interface or “API”, webhook, system call, etc.); security information (e.g., authentication information, encryption information, etc.); technical information (e.g., file locations, call information, system naming, application naming, IP address information, port information, etc.); integration flow information (e.g., push, pull, bidirectional, etc.); integration activation (e.g., scheduling or timing information, event information, one or more rules, one or more triggers or criteria, etc.); processing information (e.g., data mappings between the source and target, data validation rules, data transformations, error handling, etc.); and/or any other information used in defining, configuring, and/or integrating an application with each of any number of third-party applications and/or systems.

The computing system 310 includes the data structures 315, which can be implemented on the computing system 310 and used to perform operations involving the employment data 311 including, but not limited to, for instance: performing integration and synchronization of the employment data 311 with one or more different third-party applications and/or systems; generating and processing computer instructions across one or more different systems based on the employment data 311; and/or another operation involving the employment data 311. In an embodiment, the data structures 315 generally can include information about the properties or attributes of each of one or more entities associated with the employment data 311. Data structures 315 also can include information describing relationships associated with one or more entities associated with the employment data 311 (e.g., explicit relationships defined between entities, virtual relationships determined based on various attributes and data associated with entities, etc.). In some embodiments, the data structures 315 generally can be used in validating and processing the employment data 311 and/or other information received from third-party applications and/or systems. The data structures 315 also can be used in association with performing or otherwise carrying out one or more operations involving the employment data 311 including, but not limited to, processing requests, validating queries, generating computer instructions, processing computer instructions, generating workflows, executing workflows, generating triggers, evaluating trigger conditions, performing trigger operations, creating reports, running reports, and/or another operation involving the employment data 311.

In an embodiment, the data structures 315 can include one or more object graphs and/or any other types of data structures that provide information about entities, relationships, rules, constraints, and/or any other aspects of managing the employment data 311. For example, such object graphs and/or data structures can include one or more nodes (e.g., data objects) representing entities associated with the employment data 311 and one or more edges that connect and represent relationships between the nodes (e.g., explicit edges defining relationships between entities and data, virtual edges inferring relationships between entities and data, etc.). The data structures 315 can also include employment data and/or associated metadata. In addition, the data structures 315, together or alone, generally may represent one or more structural aspects of an application or system (e.g., such as an employment data management system that is a system of record for employment data 311 of an organization). In various examples, the data structures 315 generally may be used to support various operations performed by a system of record including, but not limited to, performing one or more operations for providing and/or implementing triggers based on one-to-many and/or many-to-one relationships between entities and/or data objects in the system of record. For example, the data structures 315 alone or in combination with configuration data and/or one or more other types of information may be used to generate new instructions in a computer language, which may include a custom computer language provided to users. Further, such new instructions generally may include one or more operations (e.g., one or more underlying data joins) that are identified and included in the generated instructions based on analyzing instructions received in the custom computer language in view of the data structures 315.

The computing system 310 includes the application object data 316, which can be implemented on the computing system 310. For example, the application object data 316 can include any information that is used to implement any type of application object or data structure for an application object that may store, reference, utilize, and/or process data. In an example, a system of record generally may support application objects that include, but are not limited to, application triggers, application reports, application workflows, application tasks, custom objects, audience, content item, and/or any other type of object.

In an embodiment, application triggers generally may include application objects that are referenced based on an event. For example, an application trigger may be referenced: based on (e.g., in response to) one or more internal application or system events (e.g., occurring within a system of record, etc.); based on (e.g., in response to) one or more external application or system events (e.g., occurring outside of a system of record, occurring in a third-party application integrated with a system of record, etc.); based on (e.g., in response to) a combination of one or more internal application or system events and one or more external application or system events; and/or based on (e.g., in response to) another event.

Generally, an application trigger may include one or more conditions to be evaluated when the application trigger is referenced by an application or system. For example, such conditions may include, but are not limited to, conditional statements that test one or more aspects of employment data 311. In one example, when the application trigger is referenced and the conditions of the application trigger are satisfied (e.g., evaluate to true), then one or more operations associated with the trigger are automatically executed. For example, the one or more operations associated with the application trigger may cause an application or system to perform one or more operations internally, may cause the application or system to perform one or more operations in association with an external application or system (e.g., based on an integration, etc.), or may cause the application or system to perform one or more operations internally and to perform one or more operations with an external application or system.

In at least one embodiment of the present disclosure, the application trigger can include a one-to-many operator that associates a first entity and/or data object with multiple second entities and/or data objects, where the application trigger can be defined based at least in part on the one-to-many operator and a custom computer language supported by, for instance, application 304, application 308, one or more applications 312, and/or another application of example computing environment 300. For example, in this or another embodiment, the application trigger can include a one-to-many operator that associates a first node of data structures 315 that represents a first entity of an organization in employment data 311 with multiple second nodes of data structures 315 that represent multiple second entities of the organization in employment data 311, where the application trigger can be defined based at least in part on the one-to-many operator and a custom computer language supported by, for instance, application 304, application 308, one or more applications 312, and/or another application of example computing environment 300.

In at least one other embodiment of the present disclosure, the application trigger can include a many-to-one operator that associates multiple first entities and/or data objects with a second entity and/or data object, where the application trigger can be defined based at least in part on the many-to-one operator and a custom computer language supported by, for instance, application 304, application 308, one or more applications 312, and/or another application of example computing environment 300. For example, in this or another embodiment, the application trigger can include a many-to-one operator that associates multiple first nodes of data structures 315 that represent multiple first entities of an organization in employment data 311 with a second node of data structures 315 that represents a second entity of the organization in employment data 311, where the application trigger can be defined based at least in part on the many-to-one operator and a custom computer language supported by, for instance, application 304, application 308, one or more applications 312, and/or another application of example computing environment 300.

In an embodiment, application reports generally may include any computer instructions that are executed by an application or system to obtain a collection of data or the resulting collection of data. Application workflows generally may refer to an object or objects that define a sequence of steps for automating a process associated with an application or system. Application tasks generally may be objects that are used to define one or more actions or pieces of work to be performed by a user or group of users. Application tasks may be assigned or delegated to one or more users or groups of users. Application tasks also may include information related to a particular task (e.g., start date, due date, etc.). Applications and systems may allow a user of an organization to create custom objects, which may define one or more custom object attributes, custom object operations, and relationships with entities provided by an application or system and/or other custom objects defined for an organization.

The computing system 310 includes the cloud development environment 317, which can be implemented on the computing system 310, for example, to provide users with access to an environment for writing, building, testing, executing, and/or performing any other types of operations involving instructions in a custom computer language. In an embodiment, the cloud development environment 317 may include and/or perform operations associated with the custom language processing engine 318 and, for example, any computer instruction compiler (not shown) and/or any computer instruction generator (not shown) associated with custom language processing engine 318. In addition, the cloud development environment 317 may run on one computing system (e.g., computing system 310) and provide one or more services to applications running on another computing system (e.g., application development environment 305 on computing system 302, cloud application development environment 309 on computing system 306, etc.). Further, the cloud development environment 317 may perform any one or more of the operations previously described with respect to application development environment 305 and/or cloud application development environment 309. Similarly, application development environment 305 and/or cloud application development environment 309 may perform any one or more of the operations described in association with cloud development environment 317.

The computing system 310 includes the custom language processing engine 318, which can be implemented on the computing system 310 and used to perform operations associated with processing requests based on instructions in a custom computer language. In various embodiments, the custom language processing engine 318 may receive requests for processing that include one or more instructions in a custom computer language. For example, such requests may be received from one or more different computing systems (e.g., computing system 302, computing system 306, computing system 310, etc.) and/or one or more different applications (e.g., application 304, application development environment 305, application 308, cloud application development environment 309, application(s) 312, cloud development environment 317, etc.). Custom language processing engine 318 may be associated with or utilize one or more computer instruction compilers (not shown) and/or one or more computer instruction generators (not shown), which for example, may be separate, part of, or integrated with the custom language processing engine 318.

In an embodiment, a computer instruction compiler of the custom language processing engine 318, can be implemented on the computing system 310 and used to perform operations associated with analyzing instructions in a custom computer language including, but not limited to, parsing and analyzing custom computer language instructions based on one or more rules associated with a custom computer language and/or associated data structures 315 to, for example: determine whether any error exists in the custom computer language instructions; identify one or more errors in the custom computer language instructions; return information about one or more of the identified errors; determine when the custom computer language instructions are free from error; and/or to complete another operation. The computer instruction compiler of the custom language processing engine 318 may include or be associated with a computer instruction generator (not shown) that generates one or more new instructions in a computer language, such as a custom computer language.

In an embodiment, a computer instruction generator of the custom language processing engine 318, can be implemented on the computing system 310 and used to generate one or more new instructions in a custom computer language. For example, the computer instruction generator may generate instructions in a custom computer language for execution based on configuration of one or more application objects and/or data associated with such application objects (e.g., application triggers, application reports, application workflows, application tasks, custom objects, audiences, content items, etc.). In one example, such instructions in the custom computer language may be executed by an application of a system of record to perform one or more operations involving the system of record and/or any third-party application integrated with the system of record. In one example, the computer instruction generator may generate instructions in any computer language, for example, to be executed in association with any application or computing system. For example, the computer instruction generator may generate instructions in a different computer language for execution with one or more other applications 312 or data stores (not shown) on or associated with computing system 310 and/or one or more other applications (e.g., application 304, application 308, third-party application 330, third-party application 332, third-party application 334) associated with other computing systems (e.g., computing system 302, computing system 306, computing system 320, computing system 322, computing system 324).

In various examples, third-party applications (e.g., third-party application 330, third-party application 332, third-party application 334) generally may be any type of computer application referenced within the present disclosure or otherwise available. In some examples, each third-party application may be associated with a respective computing system (e.g., computing system 320, computing system 322, computing system 324). In some examples, each third-party application may be associated with one or more different computing systems. In some examples, multiple third-party applications may run on each of one or more different computing systems.

In an embodiment, an application store computing system (not shown) provides an organization with access to multiple different integration applications (not shown) for integrating employment data 311 and/or associated processes with and across various applications and/or systems (e.g., application(s) 312, third-party application 330, third-party application 332, third-party application 334, etc.). An application store computing system also may provide an organization with one or more other types of applications, including but not limited to, platform utility apps that provide additional functionality to an employment data management application or system, other apps that may include integration-related applications, and/or any other types of applications. Generally, the application store computing system may provide one or more various applications for a flat fee, based on a subscription purchase, for a fee based on usage, for a fee based on a number of users, computing systems, processors, or any other criteria, as part of a limited trial, for free, and/or generally under any type of arrangement. In an embodiment the application store computing system is managed and provided by the same party that provides an employment data management system to organizations. For example, the integration applications provided by the application store computing system generally may be specialized for use with the employment data management system (e.g., and not end-user versions of applications that would be installed for general purpose use by end-users on end-user devices or for use by end-users via cloud services or any other types of services).

In an embodiment, the integration applications generally can be any application that allows an organization to manage any one or more aspects associated with providing one or more corresponding end-user applications to individual members (e.g., employees), teams, roles, departments, and/or any other grouping or categorization of individuals in an organization. For example, each of the integration applications can be used by an organization to control and automate various tasks associated with provisioning, configuring, maintaining, and integrating third-party applications. In some embodiments, one or more of the integration applications can allow an organization to configure automated assignment of a corresponding end-user application to one or more individuals, user account creation, single sign-on setup, provisioning, installation, setup, and/or maintenance of corresponding end-user applications (e.g., third-party applications or other applications available for use by end users) provided to particular individuals, groups, and/or one or more devices associated with such individuals or groups in the organization (e.g., via installation on respective user devices, via a cloud application service available to end users, etc.).

In an embodiment, one or more of the integration applications can provide integration of employment data 311 and associated services with one or more corresponding third-party applications (e.g., application 304 on computing system 302, application 308 on computing system 306, application(s) 312 on computing system 310, third-party application 330 on computing system 320, third-party application 332 on computing system 322, third-party application 334 on computing system 324, etc.) that utilize and/or perform operations based on employment data 311. For example, each of the integration applications can provide one or more of user account creation, single sign-on integration, user account suspension or removal, user management, group management, user privileges, user data access, user data control, template management, data integration, process automation, and/or any other types of integration between applications (e.g., third-party applications or other applications) that are associated with employment data 311 of an organization.

In an embodiment, the integration applications and/or other applications provided by the application store computing system may include, but are not limited to, collaboration apps, support apps, design apps, development apps, finance and legal apps, human resources (HR) and benefits apps, information technology (IT), device management, and security apps, office management apps, sales and marketing apps, charitable apps, platform utility apps, and/or other apps. Generally, various different types of applications provided by the application computing system may be organized, categorized, grouped, presented, and/or otherwise offered in any type of arrangement, and thus are not limited to any particular examples discussed herein, which are provided for illustration purposes only.

In an embodiment, collaboration apps may include, for example, any applications that provide scheduling, communications, document sharing and management, electronic signature services, project management, productivity, and/or any other types of applications that facilitate work between individuals, groups, and/or parties.

In an embodiment, support apps may include, for example, any applications that provide services associated with customer support, technical support, issue reporting, issue management and escalation, tracking and managing help desk tickets, and/or any other types of applications that facilitate customer, business, and/or technology support.

In an embodiment, design apps may include, for example, any applications that provide services associated with creating graphic designs, product designs, prototypes, drawings, graphical user interfaces, user experiences, and/or any other types of applications that facilitate the creation of designs, interfaces, and/or artistic works.

In an embodiment, development apps may include, for example, any applications that provide services associated with software development, software testing, source code control and management, source code scanning, application testing, process automation, cloud hosting and services, system monitoring, error reporting and alerts, machine learning, and/or any other types of applications that facilitate activities associated with building, maintaining, or deploying software applications.

In an embodiment, finance, operational, and legal apps may include, for example, any applications that provide services associated with accounting systems, budgeting systems, vendor management systems, payment systems, travel systems, expense management systems, supply chain systems, manufacturing systems, compliance and governance systems, vendor management systems, contract management systems, and/or any other types of applications and/or systems used to manage various aspects of an organization.

In an embodiment, human resources (HR) and benefits apps may include, for example, any applications that provide services associated with recruiting and hiring, temporary staffing, background checks, payroll and benefits, training and onboarding, retirement planning and contributions, reward and bonus programs, employee training, learning management systems, performance management, time and attendance, and/or systems any other types of applications or systems associated with employee-related activities.

In an embodiment, information technology (IT), device management, and security apps may include, for example, any applications that provide services associated with device management, technology, information security, password management, and/or any activities associated with managing applications, systems, devices, or associated technology.

In an embodiment, office management apps may include, for example, any applications that provide services associated with facilities management, receptionist services, physical access, visitor access, catering services, office layout, office assignments, and or any other types of applications or systems associated with performing office management.

In an embodiment, sales and marketing apps may include, for example, any applications that provide services associated with social media, analytics, advertising, event management, customer relationship management, content creation and distribution, public relations, business generation, and/or any other types of similar or related activities.

In an embodiment, charitable apps may include, for example, any applications that provide services associated with donations, charitable giving, crowdfunding, and/or other charitable services.

In an embodiment, platform utility apps may include, for example, any applications from a provider that allow an organization to utilize software applications, systems, or services that have been purchased or that are otherwise available from the provider. For example, a provider of an employment data management system can allow an organization to access and utilize standard services and/or enhanced services via one or more of the platform utility apps. In some embodiments, the platform utility apps operate from and/or are directly integrated with applications, systems, and/or services obtained from a provider. For example, such platform utility apps can allow one or more users of an organization to customize a particular implementation or instance of provider software that is associated with the organization. In one example, one of the platform utility apps can allow the creation and/or modification of one or more custom fields in association with one or more entities, the creation and/or modification of one or more relationships among the entities, the creation and/or modification of one or more default system rules or custom rules, the addition and/or use of custom fields, custom relationships and/or custom rules in various workflows, triggers, tasks, reports, integrations, etc. In some embodiments, users may create and modify custom fields, relationships, rules, tables, entities, and any other various aspects of an employment data management system in a utility application or otherwise using a custom computer language provided by the employment data management system.

In an embodiment, other apps may include, for example, any types of applications that may be used by individuals and/or organizations. The other apps may include, for example, any other category of integration applications and/or any other types of applications that can be executed by a computing system or device.

In an embodiment, authorized users of an organization with the appropriate privileges may access one or more services of the application store computing system directly, for example, via a website, web page, desktop application, mobile application, and/or any other type of application to browse, view, search, compare, evaluate, download, install, configure, upgrade, uninstall, and/or perform any other types of activities associated with the integration applications or any other types of applications provided via the application store computing system. In some embodiments, authorized users of an organization with the appropriate privileges may access one or more services of the application store computing system indirectly, for example, through another application (e.g., application(s) 312) and/or another computing system (e.g., computing system 310). In some embodiments, the application store computing system can be provided on the same computing system with other applications and services (e.g., running on computing system 310).

In an embodiment, any one or more users of an organization, such as an administrator, manager, or one or more other users associated with a particular role and/or one or more particular privileges each may install and/or configure each of one or more different integration applications for use by the organization. For example, any such user with the appropriate privileges may install one or more of the integration applications for the organization on the computing system 310 or any other computing systems or devices. In one or more additional and/or alternative embodiments, any such user with the appropriate privileges may configure integration data 314 associated with each of one or more integration applications. In some embodiments, one user with the appropriate privileges may delegate authority to one or more other users to perform installation and/or configuration of one or more of the integration applications for an organization.

In an embodiment, an employment data management system is provided via at least one computing system to allow each of one or more different organizations to centrally manage their own employment data 311. For example, the employment data management system can be provided as a centralized system of record for storing and managing various types of employment data 311 of an organization. The employment data management system also can provide various types of integration across different third-party applications that utilize employment data 311, that perform processing involving or based on employment data 311, and/or that are otherwise associated with employment data 311. The employment data management system also can automate various processing based on the employment data 311 including, but not limited to, the automation of processing performed across various third-party applications based on the employment data 311. In various embodiments, the employment data management system can be provided via one or more different computing systems, one or more different applications, and/or via one or more different services, for example, to one or more different organizations over a computer network.

In an embodiment, a separate instance of an employment data management system generally can be provided to each of one or more different organizations, for example, to allow each organization to independently configure, manage, and integrate their own instance of an employment data management system, and to secure and insulate employment data 311 from outside parties. For example, separate instances of an employment data management system generally may be provided to different organizations using different computer hardware devices, different software applications, different instances of software applications running in an isolated space, different databases, physically partitioned databases, and/or in various other ways.

In an embodiment, an employment data management system generally enables organizations to efficiently manage employment data 311 and associated processing that occurs based on the employment data 311. For example, an employment data management system may be used as a centralized system of record that is integrated with other computing systems and applications (e.g., third-party application 330, third-party application 332, third-party application 334, etc.) that generate, utilize, process, and/or perform activities based on employment data 311. Such integration generally allows an employment data management system to orchestrate and automate processing of employment data 311 and associated activities across numerous different applications that are not in communication or coordination with one another. In some embodiments, an employment data management system can allow appropriate users (e.g., authenticated, authorized, privileged, etc.) of an organization to manage, for example, organization information, settings of an employment data management system, onboarding of employees, offboarding of employees, employee information, organizational structure and locations, employee placement in departments and teams, workflows and tasks, reports, documents, and/or any other information associated with employment data 311.

In an embodiment, an organization uses an employment data management system that allows the organization to manage employment data 311 and activities performed based on the employment data 311. In some embodiments, an organization can install and use an employment data management system on a computing system (e.g., computing system 310 or any other computing system) that is dedicated to the organization. In one or more additional and/or alternative embodiments, an employment data management system can comprise any one or more of employment data 311, application(s) 312, application policy data 313, integration data 314, data structures 315, application object data 316, cloud development environment 317, custom language processing engine 318, and/or any other information associated with managing, processing, and performing activities associated with employment data 311. In addition, an employment data management system may provide and utilize its own custom computer language that allows users to access and perform various operations using simplified computer instructions based on structure of employment data 311. Further, an employment data management system may provide various features and user interfaces to configure and to automate the execution of triggers in the custom computer language to perform various activities within the employment data management system and across one or more other applications (e.g., third-party application 330, third-party application 332, third-party application 334, etc.) running on one or more different computing systems (e.g., computing system 320, computing system 322, computing system 324, etc.).

In one example, the above-described features and user interfaces can allow a user to configure one or more conditions and one or more operations of a trigger using a one-to-many operator of the custom computer language to define the trigger based on a one-to-many relationship between a first entity and/or data object (e.g., a first node of data structures 315) and multiple second entities and/or data objects (e.g., multiple second nodes of data structures 315) of employment data 311. In another example, such features and user interfaces can allow a user to configure one or more conditions and one or more operations of a trigger using a many-to-one operator of the custom computer language to define the trigger based on a many-to-one relationship between multiple first entities and/or data objects (e.g., multiple first nodes of data structures 315) and a second entity and/or data object (e.g., a second node of data structures 315) of employment data 311.

In an embodiment, an employment data management system may be provided by another party for use by an organization. For example, another party such as a software application provider may host or otherwise provide a separate instance of an employment data management system to each of one or more different organizations allowing each organization to independently manage their own employment data 311. In such embodiments, each separate instance of an employment data management system provided to an organization can respectively comprise any one or more of employment data 311, application(s) 312, application policy data 313, integration data 314, data structures 315, application object data 316, and/or any other information associated with managing, processing, and performing activities associated with employment data 311 for the particular organization. As such, an employment data management system may be a cloud-based platform that maintains employment data 311 and other information associated with each of one or more different organizations and that allows each of the different organizations to independently manage their own respective employment data 311 and related processes independently from any other organization.

FIG. 4 shows an example flow diagram 400 for example systems described herein. A internal user 404 can provide a request into a dashboard 408 of a custom unified field object system 412. The internal user 404 can generate via the dashboard 408 one or more location-based unified field objects. The location-based unified field objects can allow a different user (e.g., the first country user 444, the second country user 448) to work on the unified field object according to the settings of the local location. The custom uniform object system 412 may be configured to store data on one or more databases 416.

The custom uniform object system 412 can generate and/or transmit one or more objects, such as a product offering objects 420, new data requirement objects 424, data visibility and optionality objects 428, and/or visual and textual property objects 432. The product offering objects 420 can indicate one or products that are available to the first country user 444 and/or the second country user 448. The custom uniform object system 412 can transmit one or more new data requirement objects 424. The new data requirements can include requirements and/or rules for how data is passed to the first dynamic custom experience 436 and/or the second dynamic custom experience 440. The custom uniform object system 412 can additionally or alternatively define a visibility and/or set of options for a unified field object using one or more data visibility and optionality objects 428 that the internal user 404 can create. The custom uniform object system 412 may be configured to allow creation of one or more visual and textual property objects 432 that allow an end user (e.g., the first country user 444, second country user 448) to see location-based visual and/or textual properties of the unified field object.

The boundary 434 represents an access boundary between what the internal user 404 sees and/or has access to, and what the first country user 444 and/or second country user 448 can see and/or access. The first country user 444 can access a location-based user interface (e.g., the first dynamic custom experience 436) using a location-based object. Additionally or alternatively, the second country user 448 can access a second location-based interface (e.g., the second dynamic custom experience 440) using a location-based object).

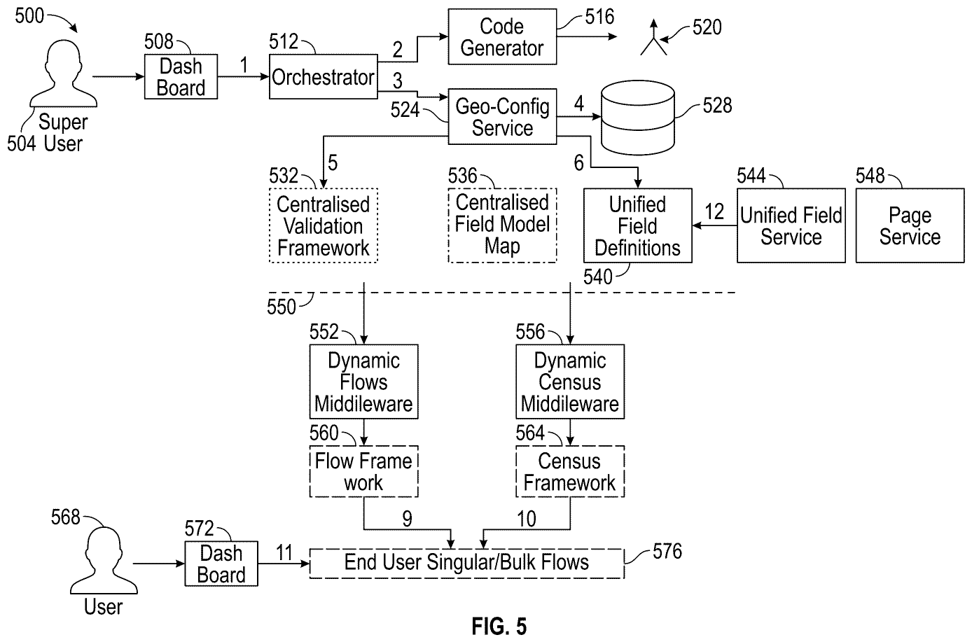

FIG. 5 shows an example flow diagram 500, according to some embodiments. A superuser 504 (e.g., the internal user 404) can generate one or more unified field objects via a dashboard 508 (e.g., the dashboard 408). The one or more unified field objects can include and/or be configured to generate one or more location-based objects. The dashboard 508 can pass the unified field objects to an orchestrator 512. The orchestrator 512 can determine what to attach to the unified field object, if anything, possibly based on internal information (e.g., in the database 528. The code generator 516 may receive the unified field object and attach code thereto using a merge 520. The code generator 516 may “own” and/or control a created entity (e.g., the unified field object), an associated code generator task, and/or related keys in order to translate one or more features of the uniform object into a local language of an associated location.

The orchestrator 512 can pass the unified field object to a geo-config 524 service. The geo-config 524 service can store hierarchical geo-aware key values that may be accessed later. The geo-config 524 may assign a hierarchy of logic to each key prioritizing first a default, then a global, key, then country, then local/state. The geo-config 524 service may manage configuration settings related to geographic data associated with one or more stored locations, such as coordinate systems, map projections, regional boundaries, and/or other spatial properties. The unified field object may have a data structure that represents a collection of spatially unified data points (e.g., geographic boundary across a specific area) and the geo-config 524 service can ensure that stored spatial data in the database 528 is accurately aligned, comparable, and/or compatible with one another.

The geo-config 524 service can provide and/or serve the unified field object (e.g., with associated geo-spatial data) to one or more of a centralized validation 532, a centralized field model map 536, and/or a unified field definitions 540 service. The centralized validation 532 can provide dynamic and/or context-aware validation equations. Additionally or alternatively, the centralized validation 532 may provide support for a plurality of variants of validation for different cohorts.

The centralized field model map 536 can provide a unified registry for each field and its mapped model attribute. For example, the centralized field model map 536 may determine which field and/or field type applies as a location-based object field for an end user. The unified field definitions 540 service can serve as a framework to unify all context-agnostic field definitions (e.g., unified fields) such as validations, defaulting, visibility, and/or persistence.

Across a boundary 550 (which may be analogous to the boundary 434), the unified field objects are passed to dynamic flows middleware 552 and/or dynamic census middleware 556. The middleware 552, 556 can serve as an adapter for flow and census framework to integrate with other objects. Additionally or alternatively, the middleware 552, 556 can ensure that proper separation exists between the unified field objects and outside data. A flow framework 560 can receive data from the dynamic flows middleware 552. Additionally or alternatively, the census framework 564 can receive data from the dynamic census middleware 556. A bulk flows 576 module can receive data (e.g., unified field objects) from the flow framework 560 and/or from the census framework 564. The bulk flows 576 module can provide a backend for a dashboard 572 for access by a user 568 (e.g., the first country user 444, the second country user 448). The bulk flows 576 module can correspond to one or more of the first dynamic custom experience 436 and/or the second dynamic custom experience 440.

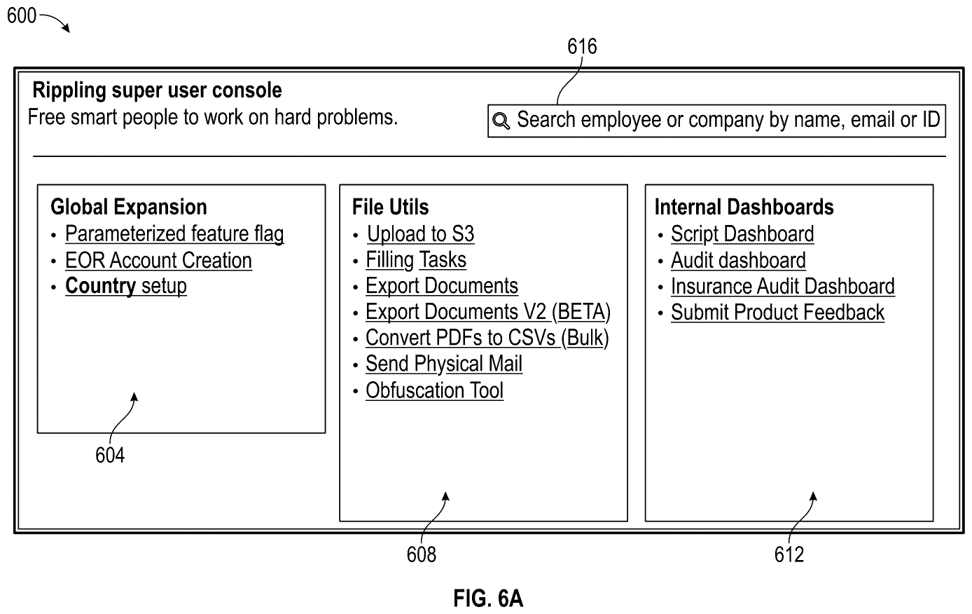

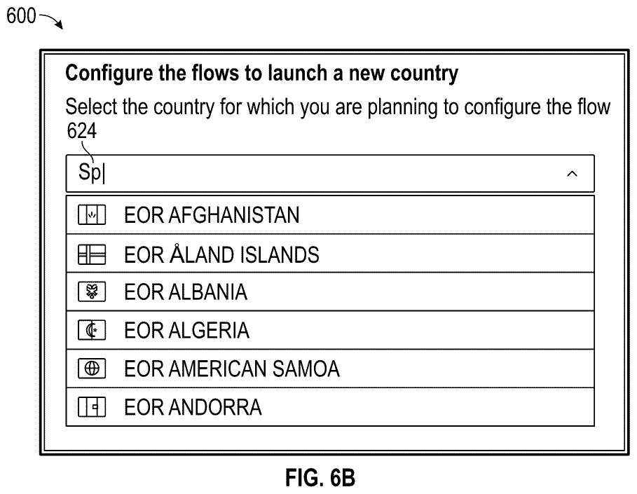

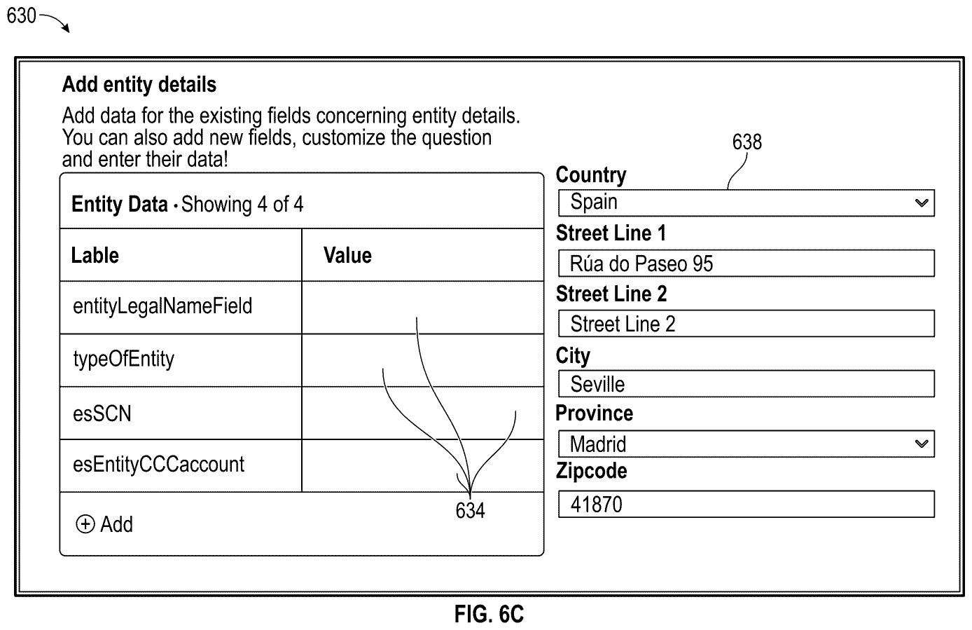

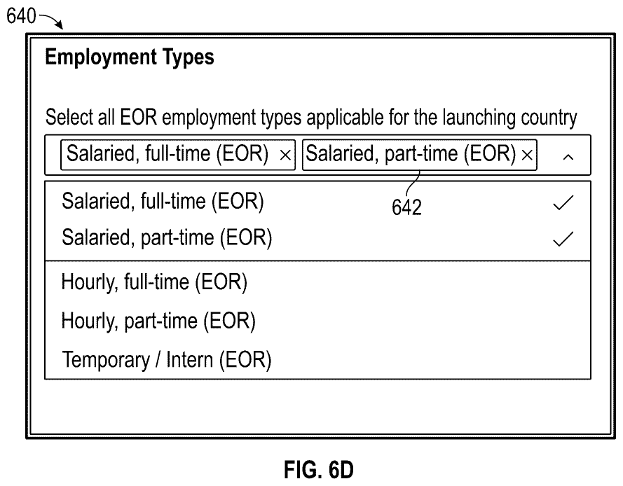

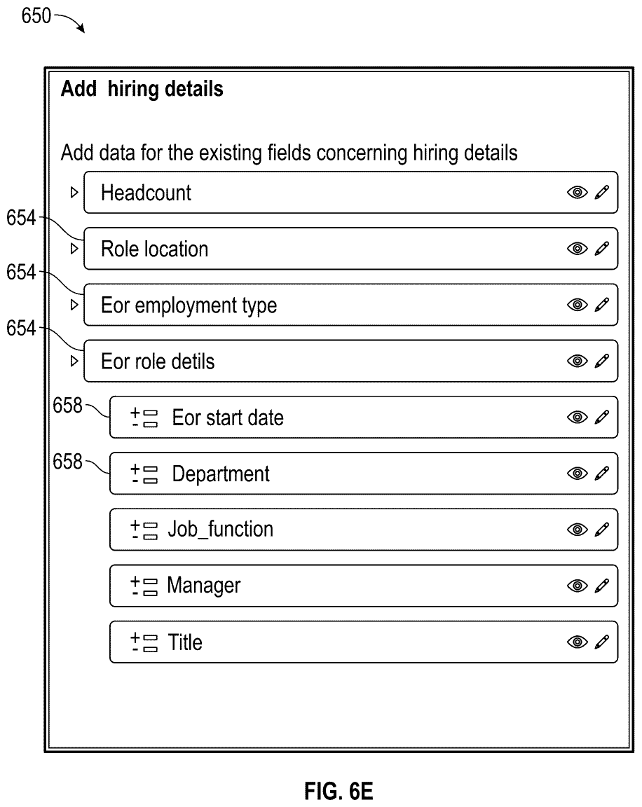

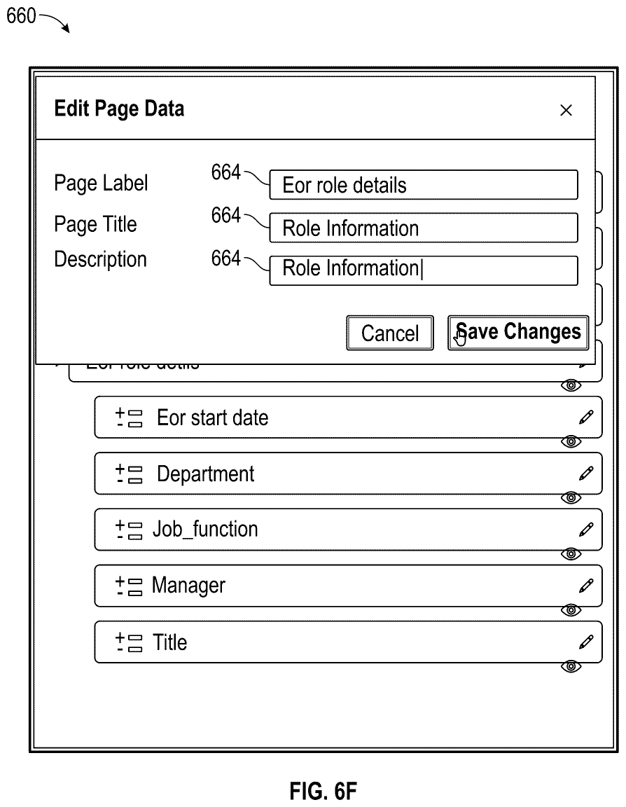

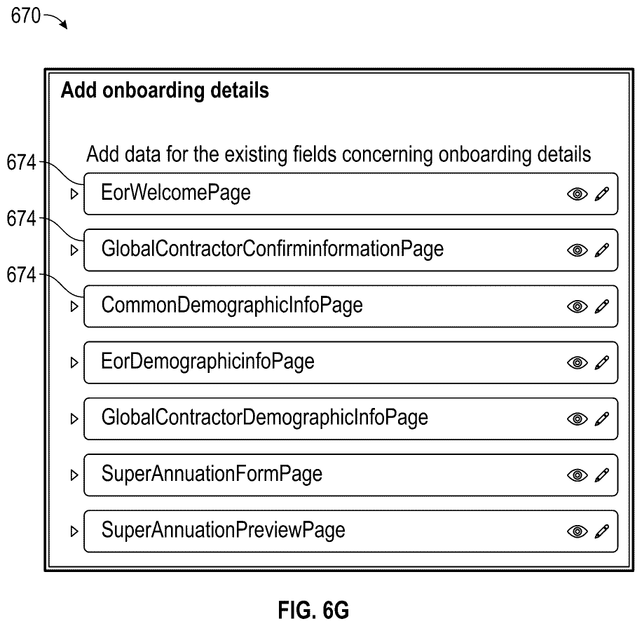

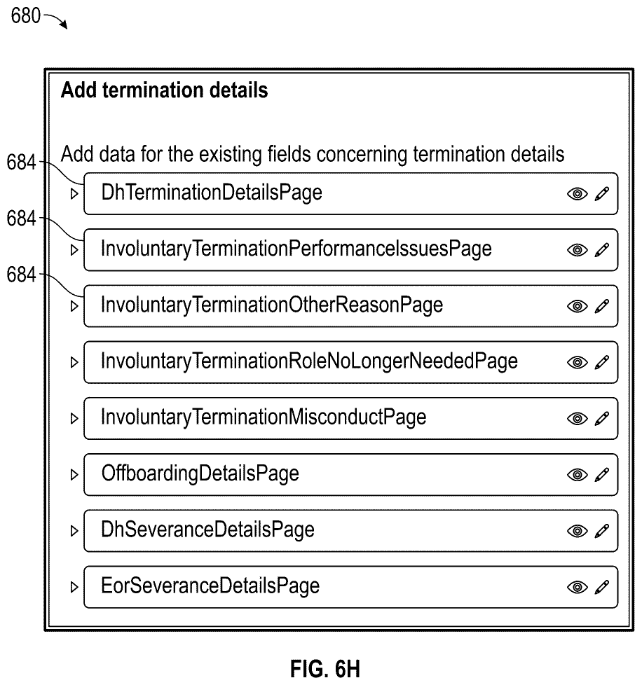

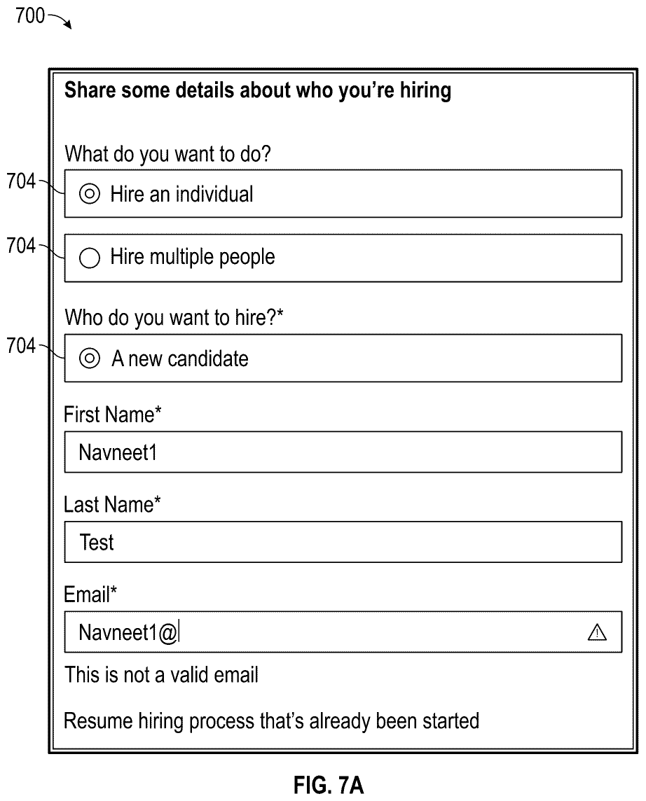

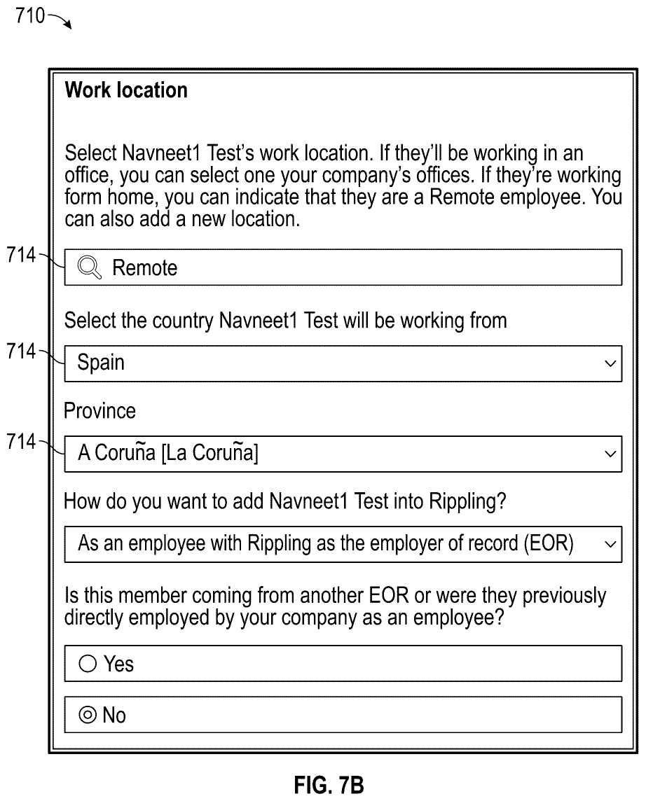

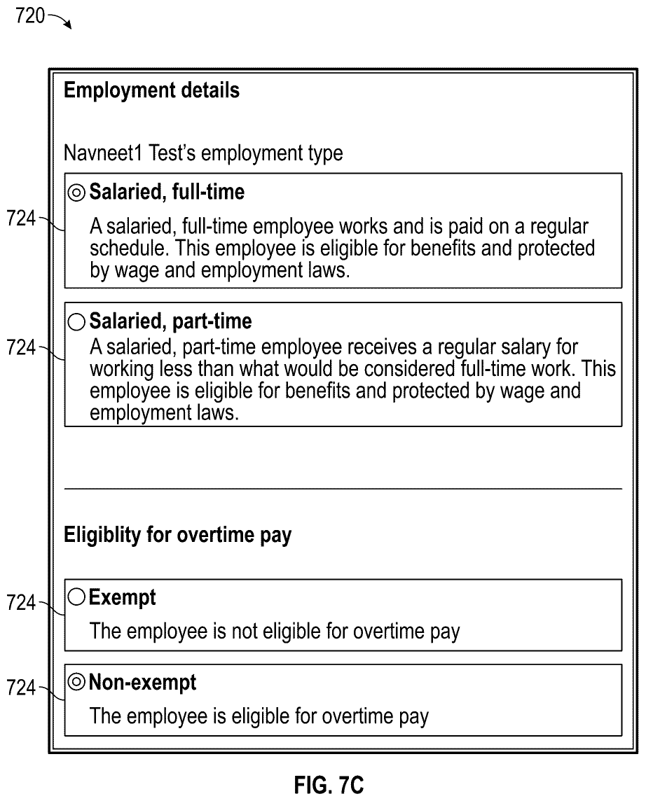

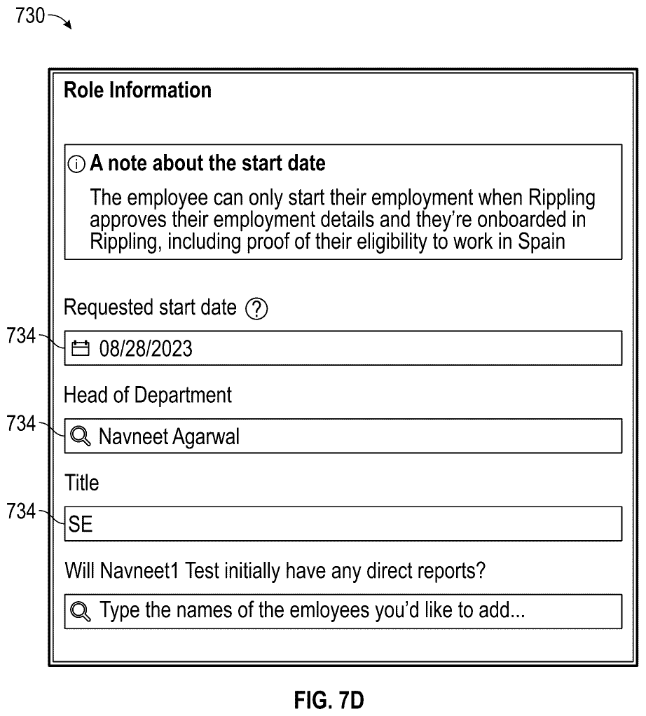

FIGS. 6A-7 depict example, non-limiting GUI pages of one or more graphical user interfaces that can be generated and/or implemented (e.g., by computing system 110) in accordance with one or more example embodiments of the present disclosure. FIGS. 6A-6H show a plurality of GUI pages (e.g., selector interfaces). In at least one embodiment described herein, computing system 110 can generate and/or provide (e.g., via network 102) the GUI pages of the graphical user interface(s) to one or more computing systems and/or devices described herein such as, for instance, computing device(s) 112, remote computing system 130, computing device(s) 132, computing device(s) 152, computing device 200, computing system 302, computing system 306, computing system 310, application store computing system 320, and/or another computing system or device. In this embodiment, computing system 110 can generate and/or provide (e.g., via network 102) the graphical user interface(s) to such computing system(s) and/or device(s) such that an entity (e.g., a user, a human) implementing (e.g., using) one or more of these computing system(s) and/or device(s) can view and/or interface with the graphical user interface(s) (e.g., via input device(s) 122, output device(s) 124, output device(s) 226, input device(s) 230).

FIGS. 6A-6H show example GUI pages that can be used by a user (e.g., internal user 404, superuser 504) for generating unified field objects. The GUI pages can include one or more unified field object fields that can be selected by the user. FIG. 6A shows an example GUI page 600 for a workflow associated with creation of a custom unified field object. The GUI page 600 includes a global expansion selection interface 604, a file utility selection interface 608, a internal dashboard selection interface 612, and a search interface 616. The global expansion selection interface 604 can include selection elements for parameterized feature flags, EOR account creation, and/or country setup. The country setup can provide a link to allow a user (e.g., the internal user 404, the superuser 504) to generate a unified field object to generate one or more location-based objects.

The file utility selection interface 608 can allow user selection of data upload, filing of tasks, exporting of documents and/or objects, document conversion, and others. The internal dashboard selection interface 612 can allow a user to select a script dashboard, audit dashboard, insurance audit dashboard, and/or feedback submission.

FIG. 6B shows an example location GUI page 620, according to certain embodiments. The location GUI page 620 can be generated in response to a selection of the country setup. The location GUI page 620 can include a location field selector 624 that allows the user to select a location (e.g., a country, region, state, city, etc.).

FIG. 6C shows an example object description interface 630, according to certain embodiments. The object description interface 630 can be generated in response to user selection of the location via the location field selector 624. The object description interface 630 can include a plurality of object field selectors 634 that allow a user to select an entity name, entity type, esSCN, esEntityCCCaccount, etc. Additionally or alternatively, in response to selection of the object field selectors 634, a plurality of object location field selectors 638, which may include one or more descriptors associated with the location. For example, the object location field selectors 638 can include a country, street address, city, province, zip code, and/or other field selector.

FIG. 6D shows an example employment type GUI page 640, according to certain examples. The employment type GUI page 640 can include a plurality of object field type selectors 642. As shown, the object field type selectors 642 can include selection of a salary selector, payment selector, employment type selector, etc.

FIG. 6E shows an example object field type interface 650 that allows the user to select one or more object field type selectors 654 and/or object field subtype selectors 658. The object field type selectors 654 can include selectors for an available headcount, a location associated with the role(s), an employment type, employer of record (EOR) role details and/or others. Additionally or alternatively, the object field subtype selectors 658 of the EOR role selectors can allow a user to select a start date, a department, a job function, a manager (e.g., role, type, etc.), a title, and/or others. These fields and/or subfields can be reflected in the location-based object fields available for use by the location-based users (e.g., first country user 444, second country user 448, etc.).

FIG. 6F shows an example object label interface 660 according to certain embodiments. The object label interface 660 can include a plurality of object label selectors 664. The object label selectors 664 can include selectors for EOR role details, role information, and/or role information that can be included in a page associated with the ultimate location-based objects. FIG. 6G shows an example object field type interface 670 according to certain embodiments. The object field type interface 670 can include a plurality of object field type selectors 674, such as those shown. FIG. 6H shows an example object field type interface 680 that shows additional object field type selectors 684. The object field type selectors 684 can include termination details, termination standards, offboarding details, severance details, and/or other details associated with an employee to be hired at the location.

FIGS. 7A-7D shows example GUI pages that may be used by location-based users for location-based objects from unified field objects created in FIGS. 6A-6H. FIG. 7A shows an example location-specific object interface 700, according to certain embodiments. The location-specific object interface 700 can include one or more location-specific object field selectors 704. The location-specific object field selectors 704 can include selectors for whether to hire one or more people, a candidate type, a name, and/or contact information.

FIG. 7B shows an example location-specific object interface 710 for generating work location details that includes a plurality of location-specific object field selectors 714. The location-specific object field selectors 714 can include a selector for an employment type (e.g., remote, local, etc.), location (e.g., country, province, location-based location details), and/or other work location details. FIG. 7C shows an example location-specific object interface 720 that can allow a user to select employment details using om location-specific object field selectors 724. The location-specific object field selectors 724 can allow the location-based user to select a salary type, employment type, overtime pay type, and/or similar.

FIG. 7D shows an example of a location-specific object interface 730 that allows a user to select role information for an employee using one or more location-specific object field selectors 734. The location-specific object field selectors 734 allow a user to select an employment start date, a role (e.g., manager type) or position, a title, and/or a type of person to whom the employee is to report.

Example unified field object interfaces described above include driving new location-based objects. In some instances, the GUI pages may allow a user to define a condition based on one or more events and/or data items that may not be associated with any object (e.g., custom unified field object, location-based object, etc.). For example, a condition can include performing an automated task at a predetermined time. A condition can include receiving a request (e.g., user request via a GUI; API request; webhook request; request from a third-party application; etc.). In some instances, a GUI for defining an automated task can include a GUI component for enabling a user to request performance of the automated task being defined.

In some instances, an interface for defining a unified field object and/or location-based object can be defined in a custom query language (e.g., Rippling Query Language, sometimes referred to as “RQL”). In some instances, a non-graphical interface (e.g., API, webhook, command line interface, etc.) can be provided to receive an automated task definition (e.g., written in a custom query language, etc.). In some instances, a GUI for defining an automated task type can include a component for inputting a query (e.g., associated with a custom query language such as RQL) defining all or part (e.g., condition, action, field used to determine a condition or action, etc.) of an automated task definition. In some instances, the GUI can include a mechanism for editing, using a custom query language, an automated task definition generated using a no-code GUI component. For example, in some instances, a computing system can generate, responsive to receiving an input via the no-code GUI component for adding a new automated task definition, a query in a custom query language for defining an automated task. In some instances, a computing system can update the query responsive to receiving an input via the no-code GUI component for modifying an automated task definition (e.g., modifying conditions, actions, etc.). In some instances, the GUI can include a navigation component (e.g., button) for navigating from a no-code GUI component to a query-editing GUI component. Responsive to a user navigating to the query-editing GUI component, the GUI can populate a query-editing input component (e.g., editable text box, etc.) with a current value of an automated task definition query. The GUI can, responsive to a user editing the query in the query-editing input component, update the current value of the automated task definition query.

In some instances, a GUI for defining a custom GUI view and/or a GUI component associated with a custom unified field object type can be displayed or hidden based on one or more security or permissions rules associated with the custom unified field object type. Such permissions associated with a custom unified field object data type can be, for example, separate from permissions associated with individual unified field objects associated with the custom unified field object type. As an illustrative example, a system administrator (e.g., the internal user 404, the superuser 504) may have permission to create custom unified field objects. For example, certain fields of data described above may require certain permissions to protect personally identifying information.

As described above, one or more of the GUI pages can include a no-code or low-code GUI enabling a user to define an application (e.g., unified field object, location-based object) without providing any user-written computer code. In some instances, a second one or more interfaces GUI for defining a custom application associated with a custom unified field object can include a GUI view for defining general properties of the application as a whole, such as an application name (e.g., display name, etc.), a system name (e.g., file name, URL, etc.), a logo or icon associated with the application, a description, one or more permissions defining which users can and cannot access the application, or other general properties.

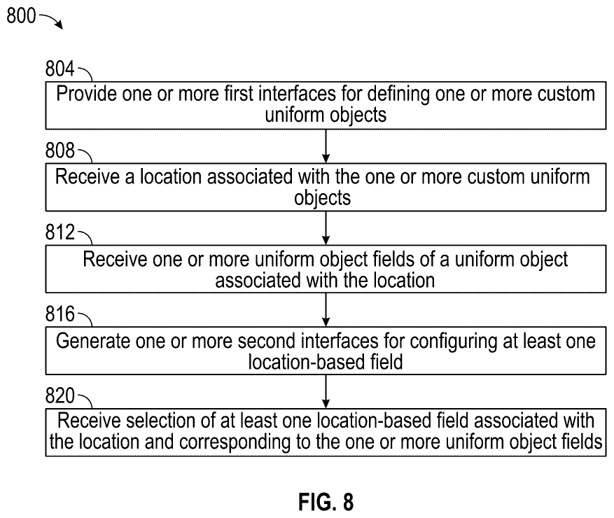

FIG. 8 depicts a flow diagram of an example method 800 for generating one or more second interfaces to one or more users for configuring at least one location-specific field, according to example embodiments of the present disclosure. One or more portions of the method 800 can be executed and/or implemented on one or more computing devices or computing systems including, for example, the computing system 18, the remote computing system 130, the one or more computing devices 152, the computing device 200, the computing system 302, the computing system 306, and/or the computing system 38. In addition, one or more portions of the method 800 can be executed or implemented as an algorithm on the hardware devices or systems disclosed herein. FIG. 8 depicts steps performed in a particular order for purposes of illustration and discussion. As such, those of ordinary skill in the art, using the disclosures provided herein, will understand that various steps of any of the methods disclosed herein can be adapted, modified, rearranged, omitted, and/or expanded without deviating from the scope of the present disclosure.

At 804, a computer system (e.g., computing system 18, computing system 38, etc.) provides one or more first interfaces for defining one or more custom uniform objects. At 808, the computing system (e.g., computer system) can receive a location associated with the one or more custom uniform objects. The computer system can access an object graph having nodes and directed edges. Each of the nodes may correspond to information associated with at least one respective data object. At least one of the directed edges can correspond to one or more hierarchical relationships among a plurality of the nodes. The computer system can access an object database configured to store a plurality of the data objects, each of the data objects having a corresponding object class and object attribute. At least one of the one or more hierarchical relationships among a subset of the plurality of data objects is based on respective object classes. The plurality of data objects can include the one or more custom uniform objects, and wherein at least one of the object field type or location-specific field comprises a node associated with one or more nodes corresponding to respective of the one or more custom uniform objects. Evaluation of the object graph may include traversing the object graph to obtain one or more associate data objects and/or relationships among the same. For example, traversing the object graph may include obtaining data objects and/or a hierarchical relationship among the data objects. The system may use any obtained associate data objects and/or relationships to determine that the condition is satisfied. For example, if an attribute of a data object obtained through traversal of the object graph matches a preset condition associated with the content item, then the condition may be satisfied. In some embodiments, the rule includes a plurality of conditions. Additionally or alternatively, each of the plurality of conditions must be met in order for the rule to be satisfied and/or for the trigger to be activated.

At 812, the computing system can receive one or more uniform object fields of a uniform object associated with the location. In some embodiments, receiving the one or more uniform object fields of the uniform object is via the one or more first interfaces. In some embodiments, the method 800 can include receiving, via the one or more first interfaces, an object field type associated with at least one of the one or more uniform object fields. The one or more first interfaces can include a graphical user interface configured to enable no-code definition of the one or more custom uniform objects. The one or more first interfaces can include one or more of the GUI pages shown in FIGS. 6A-6H. In some embodiments, the method 800 includes generating, based on the received object field type, the at least one location-specific field for selection within the one or more second interfaces. Additionally or alternatively, the method 800 can include generating, via the one or more second interfaces, a subset of available fields based on the object field type and the at least one location-specific field, wherein selection of the at least one location-specific field is from the subset of available fields. The one or more second interfaces can include one or more interfaces shown in FIGS. 7A-7D.

In some embodiments, the method 800 can include receiving, via the one or more first interfaces, a second location associated with the one or more custom uniform objects. The method 800 can include receiving one or more second uniform object fields of a second uniform object associated with the second location. The method 800 can include generating, based on the second location and the one or more second uniform object fields, one or more second interfaces for configuring at least one second location-specific field. Additionally or alternatively, the method 800 can receiving, via the one or more second interfaces, selection of at least one location-specific field associated with the second location and corresponding to the one or more second uniform object fields. Additionally or alternatively, the method 800 can include receiving, via the one or more first interfaces, a second object field type associated with at least one of the one or more second uniform object fields. Additionally or alternatively, the method 800 includes generating, based on the received second object field type, the at least one location-specific field for selection within the one or more second interfaces. In some examples, the method 800 includes generating, via the one or more second interfaces, a second subset of available fields, but not the subset of available fields, based on the second object field type and the at least one second location-specific field, wherein selection of the at least one second location-specific field is from the second subset of available fields.

In some instances, trigger data object may be added to the object graph (e.g., object graph associated with an employment management platform) and/or cause the object graph to be updated based on the trigger data object. In some instances, the object graph can include an employee object and a plurality of related objects connected to the employee object. In some instances, edges of an object graph can be directed edges and/or may be determined based on fields and/or attributes of each data object identifying related data objects in the object graph (e.g., employee object may be related to one or more computing device objects, one or more work payroll objects, etc.). In some instances, edges of an object graph can include virtual edges or reverse edges determined based on fields of objects identifying related objects. As a non-limiting illustrative example, if an Employee object explicitly identifies a Payroll object as a related object, but the Payroll object does not explicitly identify the Employee object as a related object, a reverse edge can be automatically associated with the Payroll object automatically identifying the Employee object as a related object. In some instances, adding the custom object to the object graph can include determining, based on the custom object definition, one or more related objects associated with the custom object; and defining, responsive to the determining, one or more edges (e.g., forward edges, reverse edges, links, etc.) between the custom object and the one or more related objects.

At 816, a computing system can generate, based on the location and the one or more uniform object fields, one or more second interfaces to one or more users for configuring at least one location-specific field. In some embodiments, the method 800 can include accessing a command to modify a target unified field object of the plurality of unified field objects within the object database. The system can modify the target unified field object according to the command. For example, the system may update an object class and/or attribute associated with (e.g., of) the target unified field object. The computing system may traverse the object graph to identify at least one directed edge associated with the target unified field object and/or determine (e.g., based on the identified at least one directed edges associated with the target unified field object) a parent data object having a parent relationship with the target unified field object. The parent data object may be a direct or indirect parent with the target unified field object. In some embodiments, the parent data object is associated with an individual entity (e.g., person, employee) or an organizational entity (e.g., company). In some embodiments, the child data object is associated with a mathematical or logical object attribute (e.g., a count, a change) and/or a geographic attribute (e.g., location, region). The target unified field object can have a first child relationship with the parent data object. In some examples, the trigger data object has a second child relationship (e.g., indirect, direct) with the parent data object. For example, the trigger data object and the target unified field object may both be children of the parent data object. Additionally or alternatively, the trigger data object and the target unified field object may both be children of the parent data object via different object graph traversal paths. Accessing the command to modify the target unified field object of the plurality of data objects can include accessing a selection of a nested set of data objects comprising the target unified field object. The term “nested” can mean having a hierarchical relationship where at least two nodes or data objects have a common parent (e.g., direct or indirect) relationship and where the at least two nodes or data objects have themselves a parent-child relationship.

At 820, a computer system can receive, via the one or more second interfaces, selection of at least one location-specific field associated with the location and corresponding to the one or more uniform object fields. The selection may be from an end user (e.g., the first country user 444, the second country user 448, etc.).

Numerous details are set forth in the foregoing description. However, it will be apparent to one of ordinary skill in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory. Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “obtaining,” “parsing,” “analyzing,” “accessing,” “determining,” “identifying,” “adjusting,” “modifying,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system's registers and memories into other data that can be similarly represented as physical quantities within the computer system's memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the claims.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer system comprising:
one or more hardware processors; and
one or more non-transitory computer-readable media that collectively store instructions that, when executed by the one or more processors, cause the computer system to perform operations, the operations comprising:
providing one or more first interfaces for defining one or more custom unified field objects;
receiving a location associated with the one or more custom unified field objects;
receiving one or more unified field object fields of a unified field object associated with the location, wherein at least one of the one or more unified field object fields is indicative of a child relationship with another of the one or more unified field object fields corresponding to the location;
assigning, based on the location and on the child relationship corresponding to the location, the one or more unified field object fields to a custom unified field object;
generating, based on the location, on the child relationship corresponding to the location, and on the one or more unified field object fields, one or more second interfaces for configuring at least one location-based field by one or more users; and
receiving, via the one or more second interfaces, selection of at least one location-based field associated with the location and corresponding to the one or more unified field object fields.

2. The computer system of claim 1, wherein receiving the one or more unified field object fields of the unified field object is via the one or more first interfaces.

3. The computer system of claim 1, wherein the operations further comprise:
receiving, via the one or more first interfaces, an object field type associated with at least one of the one or more unified field object fields.

4. The computer system of claim 3, wherein the operations further comprise:
generating, based on the received object field type, the at least one location-based field for selection within the one or more second interfaces.

5. The computer system of claim 4, wherein the operations further comprise:
generating, via the one or more second interfaces, a subset of available fields based on the object field type and the at least one location-based field, wherein selection of the at least one location-based field is from the subset of available fields.

6. The computer system of claim 1, wherein the one or more first interfaces comprise a graphical user interface configured to enable no-code definition of the one or more custom unified field objects.

7. The computer system of claim 5, wherein the operations further comprise:
receiving, via the one or more first interfaces, a second location associated with the one or more custom unified field objects;
receiving one or more second unified field object fields of a second unified field object associated with the second location, the second unified field object different from the unified field object;
generating, based on the second location and the one or more second unified field object fields, one or more second interfaces for configuring at least one second location-based field, wherein the one or more second interfaces are different from the one or more interfaces; and
receiving, via the one or more second interfaces, selection of at least one location-based field associated with the second location and corresponding to the one or more second unified field object fields.

8. The computer system of claim 7, wherein the operations further comprise:
receiving, via the one or more first interfaces, a second object field type associated with at least one of the one or more second unified field object fields;
generating, based on the received second object field type, the at least one location-based field for selection within the one or more second interfaces; and
generating, via the one or more second interfaces, a second subset of available fields, but not the subset of available fields, based on the second object field type and the at least one second location-based field, wherein selection of the at least one second location-based field is from the second subset of available fields.

9. The computer system of claim 8, further comprising:
an object graph comprising nodes and directed edges, each of the nodes corresponding to information associated with at least one respective data object, at least one of the directed edges corresponding to one or more hierarchical relationships among a plurality of the nodes; and
an object database configured to store a plurality of the data objects, each of the data objects having a corresponding object class and object attribute, wherein at least one of the one or more hierarchical relationships among a subset of the plurality of data objects is based on respective object classes.

10. The computer system of claim 9, wherein the plurality of data objects comprises the one or more custom unified field objects, and wherein at least one of the object field type or location-based field comprises a node associated with one or more nodes corresponding to respective of the one or more custom unified field objects.

11. The computer system of claim 7, wherein the operations further comprise:
determining, by the computing system based on one or more data access rules, that a user should have access to the one or more second interfaces; and
determining, by the computing system based on the one or more data access rules, that the user should not have access to the one or more first interfaces.

12. A computer-implemented method comprising:
providing one or more first interfaces for defining one or more custom unified field objects;
receiving a location associated with the one or more custom unified field objects;
receiving one or more unified field object fields of a unified field object associated with the location, wherein at least one of the one or more unified field object fields is indicative of a child relationship with another of the one or more unified field object fields corresponding to the location;
assigning, based on the location and on the child relationship corresponding to the location, the one or more unified field object fields to a custom unified field object;
generating, based on the location, on the child relationship corresponding to the location, and on the one or more unified field object fields, one or more second interfaces for configuring at least one location-based field by one or more users; and
receiving, via the one or more second interfaces, selection of at least one location-based field associated with the location and corresponding to the one or more unified field object fields.

13. The method of claim 12, wherein receiving the one or more unified field object fields of the unified field object is via one or more first interfaces.

14. The method of claim 12, further comprising:
receiving, via the one or more first interfaces, an object field type associated with at least one of the one or more unified field object fields.

15. The method of claim 14, further comprising:
generating, based on the received object field type, the at least one location-based field for selection within the one or more second interfaces.

16. The method of claim 15, further comprising:
generating, via the one or more second interfaces, a subset of available fields based on the object field type and the at least one location-based field, wherein selection of the at least one location-based field is from the subset of available fields.

17. The method of claim 12, wherein the one or more first interfaces comprise a graphical user interface configured to enable no-code definition of the one or more custom unified field objects.

18. The method of claim 16, further comprising:
receiving, via the one or more first interfaces, a second location associated with the one or more custom unified field objects;
receiving one or more second unified field objects of a second unified field object associated with the second location;
generating, based on the second location and the one or more second unified field objects, one or more second interfaces for configuring at least one second location-based field; and
receiving, via the one or more second interfaces, selection of at least one location-based field associated with the second location and corresponding to the one or more second unified field objects.

19. The method of claim 18, further comprising:
receiving, via the one or more first interfaces, a second object field type associated with at least one of the one or more second unified field objects;
generating, based on the received second object field type, the at least one location-based field for selection within the one or more second interfaces; and
generating, via the one or more second interfaces, a second subset of available fields, but not the subset of available fields, based on the second object field type and the at least one second location-based field, wherein selection of the at least one second location-based field is from the second subset of available fields.

20. The method of claim 19, further comprising:
determining, based on one or more data access rules, that a user should have access to the one or more second interfaces; and
determining, based on the one or more data access rules, that the user should not have access to the one or more first interfaces.

21. The computer system of claim 7, wherein the operations further comprise:
receiving, via the one or more second interfaces, a target location;
determining that the target location corresponds to the location; and
displaying, based on determining that the target location corresponds to the location, the one or more unified field object fields to the one or more users.
